(19) United States
(12) Patent Application Publication
(10) Pub. No.: US 2018/0165240 A1
(43) Pub. Date: Jun. 14, 2018

(54) INTERCONNECT NETWORK SUPPORTING MULTIPLE CONSISTENCY MECHANISMS, MULTIPLE PROTOCOLS, AND MULTIPLE SWITCHING MECHANISMS

(71) Applicant: INTEL IP CORPORATION, Santa Clara, CA (US)

(72) Inventors: Helmut Reinig, Isen (DE); Todor M. Mladenov, Ottobrunn (DE); Simona Bernardi, Munchen (DE); Robert De Gruijl, San Francisco, CA (US)

(21) Appl. No.: 15/373,033

(22) Filed: Dec. 8, 2016

(51) Int. Cl. G06F 13/40; G06F 13/16; G06F 13/42

(52) U.S. Cl. CPC G06F 13/4022; G06F 13/4282; G06F 13/1673; G06F 13/1642

(57) ABSTRACT

A network interface is provided which comprises: a first buffer configured to buffer a first flow of a first type of commands from a first device to a second device, wherein the first device is configured in accordance with a first bus interconnect protocol and the second device is configured in accordance with a second bus interconnect protocol; a second buffer configured to buffer a second flow of a second type of commands from the first device to the second device; and an arbiter configured to arbitrate between the first flow and the second flow, and selectively output one or more commands of the first type and one or more commands of the second type.

### BACKGROUND

A computing system generally has a multitude of components designed and manufactured by different manufacturers. These components can follow different interconnect protocols for communication. For example, some of these components can use one or more industry standard bus protocols and consistency mechanisms, while others may use proprietary bus protocol developed by a specific vendor. An interconnect network that interconnects all these components has to support various types of bus protocols and consistency mechanisms.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 illustrates a system comprising two devices communicating using an appropriate request/response (RR) based interconnect protocol.

FIG. 2 illustrates a system comprising two devices communicating using an appropriate posted (P)/Non-posted (NP)/completion (C) based interconnect protocol (e.g., a PNC interconnect protocol).

FIG. 3 illustrates a system comprising two PNC devices communicating via a PNC protocol over a shared connection, according to some embodiments.

FIG. 4 illustrates a system comprising a RR device and a PNC device communicating over a shared connection, according to some embodiments.

FIG. 5 illustrates a system comprising two RR devices communicating over a shared connection, according to some embodiments.

FIG. 6 illustrates an interconnect network connecting one or more PNC devices with one or more RR devices, according to some embodiments.

FIG. 7 illustrates transmission of write data from a processor component acting as producer of data to a memory component of a network, according to some embodiments.

FIG. 8 illustrates communication between a producer of data and a consumer of data, according to some embodiments.

FIG. 9 illustrates communication between a consumer of data and a memory, according to some embodiments.

FIG. 10 illustrates another interconnect network connecting one or more PNC devices with one or more RR devices, where an interrupt generator is within a network interface, according to some embodiments.

FIG. 11 illustrates communication between a network interface and a consumer of data, according to some embodiments.

FIG. 12 illustrates another interconnect network connecting one or more PNC devices with one or more RR devices, where a non-posted command is executed after a series of posted write command, according to some embodiments.

FIG. 13 illustrates a system comprising two PNC devices communicating via the PNC protocol, where a common buffer stores multiple command flows, according to some embodiment.

FIG. 14 illustrates another system comprising two PNC devices communicating via the PNC protocol, where a common buffer stores multiple command flows, according to some embodiment.

FIG. 15 illustrates a system for controlling a buffer output of a buffer, according to some embodiments.

FIG. 16 illustrates another system for controlling a buffer output of a buffer, according to some embodiments.

FIG. 17 illustrates another system for controlling a buffer output of a buffer, according to some embodiments.

FIG. 18 illustrates another interconnect network connecting one or more PNC devices with one or more RR devices, according to some embodiments

FIG. 19 illustrates a smart device, a computing device or a computer system or a SoC (System-on-Chip), where various components of the computing device 2100 are interconnect over a network 2190, according to some embodiments.

### DETAILED DESCRIPTION

In some embodiments, a network comprises multiple routers and network interfaces, where the network is configured to interconnect multiple devices operating in accordance with two or more bus interconnect protocols. In an example, each device is connected to a corresponding router via a corresponding network interface. The network operates in accordance with, for example, a bus interconnect protocol that uses posted commands, non-posted commands, and completion commands to communicate. For example, the network operates in accordance with the Peripheral Component Interconnect Express (PCIe) protocol (e.g., as specified in the PCI Express 1.0a standard released in 2003, or any revisions thereafter).

In some embodiments, some of the devices can operate in accordance with a bus interconnect protocol that uses requests and responses for communicating. In some embodiments, a network interface includes a translator to translate between the protocol of the corresponding device and the protocol used by the network.

In some embodiments, a network interface of the network comprises different buffers for different types of flows, e.g., a first buffer for a flow of posted commands, a second buffer for a flow of non-posted commands, and a third buffer for a flow of completion commands. In some embodiments, an operating mode of the buffers can be selected to optimize between latency and throughput, e.g., based on one or more factors of the network. In some embodiments, the routers of the network are arranged in a tree-like structure, e.g., to ensure that a router is connected to another router via a unique and single connection path.

There are many technical effects of the various embodiments. For example, the network supports varied devices having different bus interconnect protocols. In an example, the unique structure of the network (e.g., the unique structure of the buffers in the network interface, the tree like structure of the routers, etc.) ensure that various consistency requirement of the interconnect protocol of the network is fulfilled. For example, having different buffers for different types of flows ensure that a specific type of command can overtake another specific type of command, thereby facilitating fulfillment of some of the requirements of the interconnect protocol of the network. In some special situations, the number of buffers in a network interface can be reduced, without violating these requirements, and yet achieving a smaller footprint of the network interface.

In the following description, numerous details are discussed to provide a more thorough explanation of embodiments of the present disclosure. It will be apparent, however, to one skilled in the art, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.” The terms “substantially,” “close,” “approximately,” “near,” and “about,” generally refer to being within +/−10% of a target value.

Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C). The terms “left,” “right,” “front,” “back,” “top,” “bottom,” “over,” “under,” and the like in the description and in the claims, if any, are used for descriptive purposes and not necessarily for describing permanent relative positions.

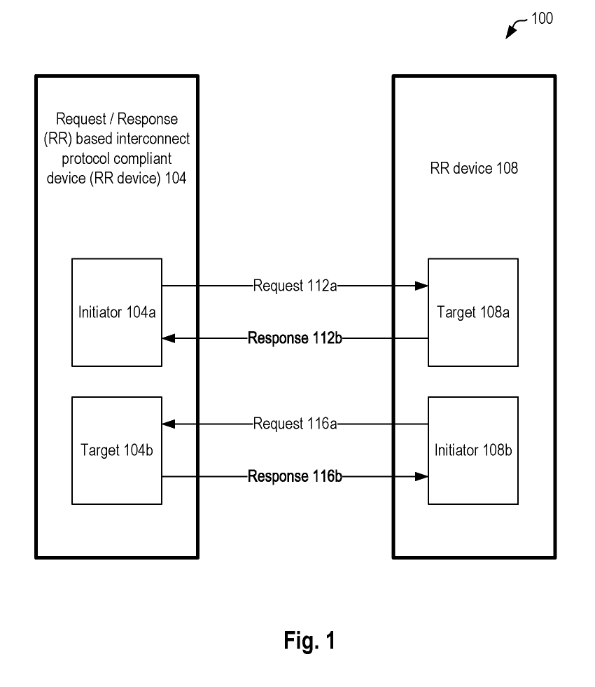

FIG. 1 illustrates a system 100 comprising two devices 104 and 108 communicating using an appropriate request/response (RR) based interconnect protocol. As the devices 104 and 108 communicate using a RR based interconnect protocol, each of the devices 104 and 108 is also referred to herein as “RR based interconnect protocol compliant device,” and/or as a “RR device.”

Various interconnect protocols employ requests and responses for communication. For example, the Advanced Peripheral Bus (APB) protocol (e.g., as specified in the Advanced Microcontroller Bus Architecture (AMBA) specification 2.0, released in 1999 by ARM Limited, or any revisions thereafter) employs requests and responses to communicate between two devices. In another example, the AMBA High-performance Bus (AHB) protocol (e.g., as specified in the AMBA specification 2.0, or any revisions thereafter) also employs requests and responses to communicate between two devices. In another example, the Advanced eXtensible Interface (AXI) protocol (e.g., as specified in the AMBA specification 2.0, or any revisions thereafter) also employs requests and responses to communicate between two devices. In another example, the Open Core Protocol (OCP) protocol (e.g., as specified in the OCP International Partnership (OCP-IP) specification) also employs requests and responses to communicate between two devices. In yet another example, various types of memory products (e.g., a static random-access memory (SRAM)) may also employ requests and responses to communicate between two devices. For purposes of this disclosure, a RR based interconnect protocol compliant device (or simply a RR device, e.g., the devices 104 and 108 of FIG. 1) would imply a device that is compliant with an appropriate interconnect protocol that is based on request and response commands, and a RR based interconnect protocol (or a RR interconnect protocol) would imply an appropriate interconnect protocol that is based on request and response commands. Although some examples of such protocols are discussed herein above, the examples are not exhaustive, and an RR based interconnect protocol may also include interconnect protocols not specified above.

Referring to FIG. 1, each of the devices 104 and 108 can act in a master configuration and/or a slave configuration. For example, when the device 104 is configured as a master and the device 108 is configured as a slave, the device 104 acts as an initiator 104a and the device 108 acts as a target 108a. The initiator 104a transmits a request 112a to the target 108a, in response to which the target 108a transmits a response 112b to the initiator 104a.

In some embodiments, the request 112a and the response 112b can be of any appropriate type. As an example, the request 112a can be a read request, while the response 112b can include the corresponding read data. In another example, the request 112a can be a write command, and the response 112b can comprise a write acknowledgement. In another example, the request 112a can be any appropriate command, and the response 112b can be an acknowledgement, data requested via the request 112a, and/or the like.

In some embodiments, a posted request (e.g., a posted request 112a) is a request that does not trigger any response. For example, a posted write request is a write request that does not require an acknowledgement (e.g., does not require a response). For one or more of the above discussed RR protocols, in some embodiments, a request and/or a response (e.g., the request 112a and the response 112b) can be commands that, for example, include addresses, data, and/or flow control signals (although in some examples, a request and/or a response may not necessarily include all of address, data, or flow control signals).

Similarly, in an example, when the device 104 is configured as a slave and the device 108 is configured as a master, the device 104 acts as a target 104b and the device 108 acts as an initiator 108b. The initiator 108b transmits a request 116a to the target 104b, in response to which the target 104b transmits a response 116b to the initiator 108b.

In some embodiments, both the devices 104 and 108 can act as masters and slaves at the same time. Merely as an example, the device 104 can be a direct memory access (DMA) controller with a slave port for configuration and a master port for memory access, while the device 108 can be a processing core with a local memory and/or a cache. In such an example, the device 108 can operate as the master port, and the slave port of the device 108 can give access to the local memory and/or the cache memory.

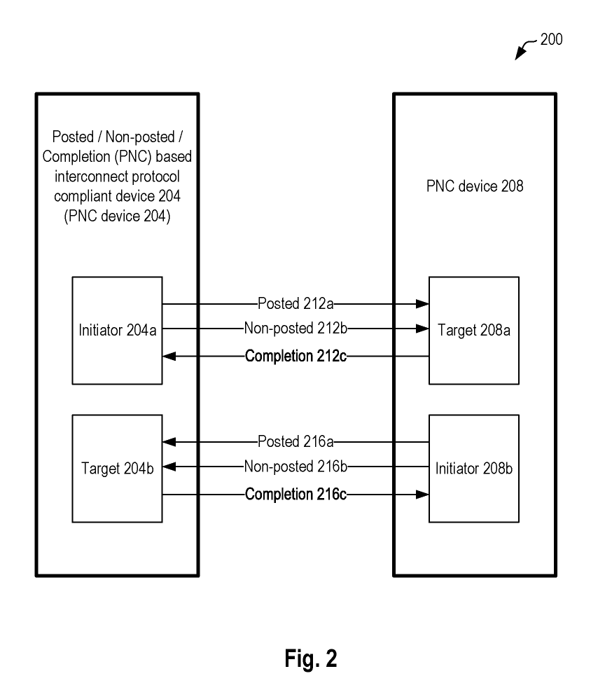

FIG. 2 illustrates a system 200 comprising two devices 204 and 208 communicating using an appropriate posted (P)/Non-posted (NP)/completion (C) based interconnect protocol (e.g., a PNC based interconnect protocol). As the devices 204 and 208 communicate using a PNC based interconnect protocol, each of the devices 204 and 208 is also referred to herein a “PNC based interconnect protocol compliant device,” and/or as a “PNC device.”

Various interconnect protocols employ posted/non-posted and completion signals for communication. For example, the Peripheral Component Interconnect (PCI), the Peripheral Component Interconnect Express (PCIe) protocol (e.g., as specified in the PCI Express 1.0a standard released in 2003, or any revisions thereafter), etc. employ posted, non-posted and completion commands for communication. Many different protocols can be derived from, for example, the PCI protocol, or the PCIe protocol. For example, the Intel On-Chip System Fabric (IOSF) standard developed by INTEL® is derived from PCIe, which also employs posted, non-posted and completion commands for communication. Thus, the devices 204 and 208 are compliant with any of the PCI standard, the PCIe standard, any protocol derived thereof (e.g., the IOSF standard), or another appropriate interconnect standard employing posted, non-posted and/or completion commands to communicate. For purposes of this disclosure, a PNC based interconnect protocol compliant device (or simply a PNC device, e.g., the devices 204 and 208 of FIG. 2) would imply a device that is compliant with an appropriate interconnect protocol that is based on posted (P), non-posted (NP) and/or completion (C) commands, and a PNC based interconnect protocol (also referred to as “a PNC protocol”) would imply an appropriate interconnect protocol that is based on the above discussed PNC commands. Although some examples of such protocols are discussed above, the examples are not exhaustive, and a PNC based interconnect protocol may also include interconnect protocols not specified herein above.

Referring again to FIG. 2, each of the devices 204 and 208 can act in a master configuration or a slave configuration. For example, when the device 204 is configured as a master and the device 208 is configured as a slave, the device 204 acts as an initiator 204a and the device 208 acts as a target 208a. The initiator 204a can transmit a posted command 212a (henceforth also referred to as “posted 212a”) and/or a non-posted command 212b (henceforth also referred to as “non-posted 212b”) to the target 208a, and receive a completion command 212c (henceforth also referred to as “completion 212c”) from the target 208a.

In some embodiments, a posted command (e.g., the posted 212a) generally represents a command that do not require an acknowledgement or a response. On the other hand, a non-posted command (e.g., the non-posted 212b) generally represents a command that requires an acknowledgement or a response. A completion command (e.g., the completion 212c) represents a response or an acknowledgement to a non-posted command.

As an example, a non-posted command (e.g., the non-posted 212b) can be a read command, and the corresponding completion command (e.g., the completion 212c) can include the corresponding read data. In another example, a non-posted command can be a write command that requires a write acknowledgement, and the corresponding completion command can be the write acknowledgement issued in response to the write command. In an example, a posted command (e.g., the posted 212a) can be a write command that does not require an acknowledgement.

In an example, when the device 204 is configured as a slave and the device 208 is configured as a master, the device 204 acts as a target 204b and the device 208 acts as an initiator 208b. The initiator 208b can transmit a posted command 216a (henceforth also referred to as “posted 216a”) and/or a non-posted command 216b (henceforth also referred to as “non-posted 212b”) to the target 204b, and receive a completion command 216c (henceforth also referred to as “completion 216c”) from the target 204b.

In some embodiments, a PNC interconnect protocol generally has rules associated with an order in which various simultaneous or near simultaneous commands are arbitrated and communicated. In an example, a PNC interconnect protocol has three primary flow of commands: a posted flow (e.g., P flow associated with a flow of posted commands), a non-posted flow (e.g., NP flow associated with a flow of non-posted commands), and a completion (e.g., C flow associated with a flow of completion commands). A flow of a specific type of command refers to a transmission of a stream or a sequence of commands of the specific type. For example, a P flow refers to a transmission of a stream or a sequence of posted commands.

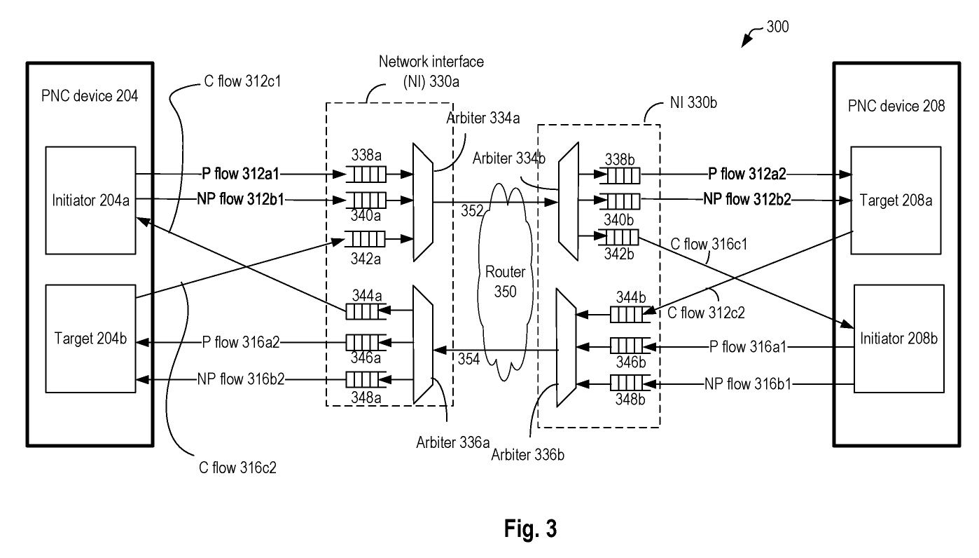

FIG. 3 illustrates a system 300 comprising the PNC devices 204 and 208 of FIG. 2 communicating via the PNC protocol over a shared connection, according to some embodiments. As discussed with respect to FIG. 2, the devices 204 and 208, which are PNC devices, communicate with each other using posted, non-posted, and completion commands. Thus, the devices 204 and 208 are associated with P flows, NP flows, and C flows.

In some embodiments, the devices 204 and 208 communicate with each other via a network interface (NI) 330a and a NI 330b. For example, the NI 330a is coupled to the device 204, the NI 330b is coupled to the device 208, and the NIs 330a and 330b are coupled via a router 350 and signal lines 352 and 354. Although a single router 350 and two signal lines 352, 354 are illustrated in FIG. 3 as an example, the router 350 and the two signal lines 352, 354 can represent a network comprising multiple routers, switches, buses, multi-layer buses, crossbars, time-multiplexed wires for command and data information (or, for example, separate wires for command and data information), any other appropriate network components, etc.

In some embodiments, the NI 330a comprises an arbiter 334a and an arbiter 336a, and the NI 330b comprises an arbiter 334b and an arbiter 336b. The NI 330a further comprises buffers 338a, 340a, 342a, 344a, 346a, and 348a. The NI 330b further comprises buffers 338b, 340b, 342b, 344b, 346b, and 348b. The buffers in the NIs 330a and 330b are, for example, first-in first-out (FIFO) buffers.

As discussed with respect to FIG. 2, the device 204 can act as an initiator 204a and a target 204b, while the device 208 can also act as a target 208a and an initiator 208b. The initiator 204a generates a P flow 312a1 and a NP flow 312b1 for the target 208a, and receives a C flow 312c1 from the target 208a. In an example, the P flow 312a1 is received by the buffer 338a, and transmitted by the buffer 338a to the arbiter 334a. Similarly, the NP flow 312b1 is received by the buffer 340a, and transmitted by the buffer 340a to the arbiter 334a. Also, the arbiter 336a selectively outputs the C flow 312c1 to the buffer 344a, which is received by the initiator 204a.

The initiator 208b generates a P flow 316a1 and a NP flow 316b1 for the target 204b, and receives a C flow 316c1 from the target 204b. In an example, the P flow 316a1 is received by the buffer 346b, and transmitted by the buffer 346b to the arbiter 336b. Similarly, the NP flow 316b1 is received by the buffer 348b, and transmitted by the buffer 348b to the arbiter 336b. Also, the arbiter 334b selectively outputs the C flow 316c1 to the buffer 342b, which is received by the initiator 208b.

The target 204b receives a P flow 316a2 and a NP flow 316b2 via the buffers 346a and 348b, respectively, and the arbiter 336a. The target 204b also transmits the C flow 316c2 to the arbiter 334a via the buffer 342a.

The target 208a receives a P flow 312a2 and a NP flow 312b2 via the buffers 338b and 340b, respectively, and the arbiter 334b. The target 208a also transmits the C flow 312c2 to the arbiter 336b via the buffer 344b.

In some embodiments, an output of the arbiter 334a is coupled to an input of the arbiter 334b via a signal line 352. In some embodiments, an output of the arbiter 336b is coupled to an input of the arbiter 336a via a signal line 354.

In some embodiments, the arbiter 334a arbitrates between the P flow 312a1, the NP flow 312b1, and the C flow 316c1. For example, the arbiter 334a selectively outputs a P command, a NP command, or a C command from its input to the signal line 352, such that the commands in the P flow 312a1, the NP flow 312b1, and the C flow 316c1 are transmitted to the arbiter 334b in a time multiplexed manner. Also, the arbiter 334b receives the time multiplexed P, NP and C commands over the signal line 352, and selectively outputs these commands respectively as the P flow 312a2, NP flow 312b2, and the C flow 316c1. Thus, the initiator 204a transmits a P command to the target 208a via the P flow 312a1, via the signal line 352, and via the P flow 312a2. Similarly, the initiator 204a transmits a NP command to the target 208a via the NP flow 312b1, via the signal line 352, and via the NP flow 312b2.

In some embodiments, the arbiter 336b arbitrates between the P flow 316a1, the NP flow 316b1, and the C flow 312c2. For example, the arbiter 336b selectively outputs a P command, a NP command, or a C command from its input to the signal line 354, such that the commands in the P flow 316a1, the NP flow 316b1, and the C flow 312c2 are transmitted to the arbiter 336a in a time multiplexed manner. Also, the arbiter 336a receives the time multiplexed P, NP and C commands over the signal line 354, and selectively outputs these commands respectively as the P flow 316a2, the NP flow 316b2, and the C flow 312c1. Thus, the initiator 208b transmits a P command to the target 204b via the P flow 316a1, via the signal line 354, and via the P flow 316a2. Similarly, the initiator 208b transmits a NP command to the target 204b via the NP flow 316b1, via the signal line 354, and via the NP flow 316b2.

It is to be noted that unlike the P and NP flows in FIG. 3, the C flows are cross channeled. For example, the initiator 204a receives a C command from the target 208a via the buffer 344b, the arbiter 336b, the arbiter 336a, and the buffer 344a. Similarly, the initiator 208b receives a C command from the target 204b via the buffer 342a, the arbiter 334a, the arbiter 334b, and the buffer 342b.

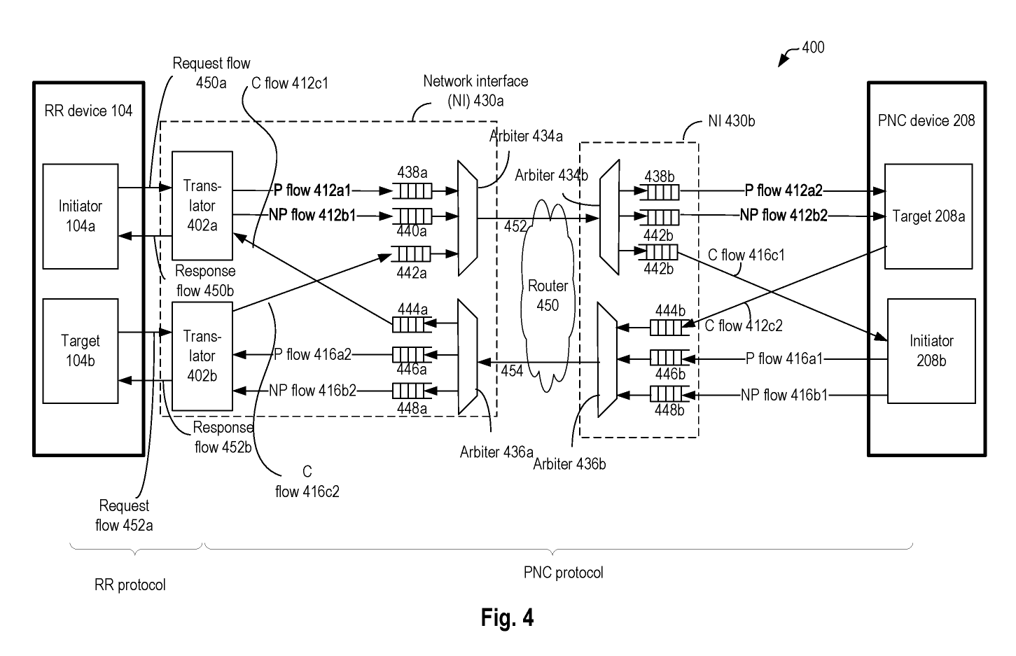

FIG. 4 illustrates a system 400 comprising the RR device 104 of FIG. 1 and the PNC device 208 of FIG. 2 communicating over a shared connection, according to some embodiments. As the device 104 is a RR device, the device 104 can communicate using the RR protocol, and does not communicate via the PNC protocol. On the other hand, the device 208 communicates via the PNC protocol, and not via the RR protocol.

In some embodiments, the system 400 comprises a NI 430a and a NI 430b. The NI 430a, for example, comprises a translator 402a configured to receive requests (e.g., receive a request flow 450a) from the initiator 104a of the device 104, and transmit responses (e.g., transmit a response flow 450b) to the initiator 104a. Also, a translator 402b is similarly configured to receive requests (e.g., receive a request flow 452a) from the target 104b of the device 104, and transmit responses (e.g., transmit a response flow 452b) to the target 104b. In some embodiments, the translators 402a and 402b are combined or integrated in a single translator.

In some embodiments, individual request in the request flow 450a is translated by the translator 402a to either a P command of a P flow 412a1, or a NP command of a NP flow 412b1. For example, the translator 402a parses and analyzes each request in the request flow 450a, and translates each request to either a P command or a NP command, e.g., based at least in part on the contents of the request.

For example, a read request in the request flow 450a (e.g., which is for reading data) is translated to a NP command (e.g., because a read request usually requires a response including the requested data, which is synonymous to a completion command). In another example, a write request in the request flow 450a, which requires an acknowledgement, is also translated to a NP command (e.g., because such a write request usually requires an acknowledgment, which is also synonymous to a completion command). In another example, a write request in the request flow 450a, which does not require an acknowledgement, is translated to a P command (e.g., because such a write request does not require an acknowledgment or a completion command).

In some embodiments, the translator 402a receives a C flow 412c1, which is translated to the response flow 450b. For example, the translator 402a translates the C commands in the C flow 412c1 to corresponding responses in the response flow 450b.

The translator 402b also acts in a similar manner. For example, the translator 402b receives a P flow 416a2 and a NP flow 416b2 from an arbiter 436a, which the translator 402b translates into the response flow 452b. Similarly, the translator 402b receives a request flow 452a, which the translator 402b translates into a C flow 416c2.

The section to the left side of the translators 402a and 402b in FIG. 4 are similar to the corresponding section of FIG. 3. For example, the section to the left of the translators 402a and 402b comprises arbiters 434a, 434b, 436a, 436b, buffers 438a, . . . , 448a, 438b, 448b, a router 450, signal lines 452 and 454, etc., which are similar to the corresponding components of FIG. 3, and hence, these components will not be discussed in further details herein.

The communication between the device 104 and the translators 402a, 402b are based on the RR protocol, while the communication between the translators 402a, 402b and the device 208 are based on the PNC protocol. Thus, the translators 402a and 402b act as a bridge between these two protocols.

In some embodiments, because the NI 430a is coupled to a RR device 104, the NI 430a is referred to as a RR NI. Similarly, because the NI 430b is coupled to a PNC device 208, the NI 430b is referred to as a PNC NI.

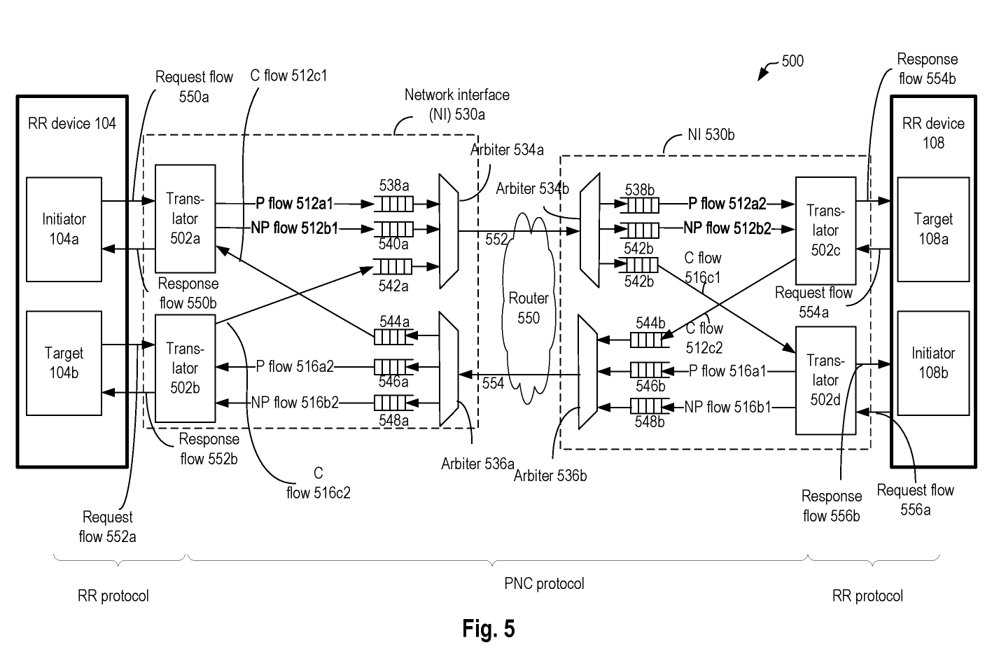

FIG. 5 illustrates a system 500 comprising the RR devices 104 and 108 of FIG. 1 communicating over a shared connection, according to some embodiments. The system 500 of FIG. 5 is at least in part similar to the system 400 of FIG. 4. For example, similar to the system 400, the system 500 comprises translators 502a and 502b in the NI 530a that translates commands between the PNC protocol and the RR protocol. Also, a NI 530b also comprises translators 502c and 502d configured to translate between the PNC protocol and the RR protocol. The translators 502a and 502b, and also the translators 502c and 502d of the system 500 is configured similar to the translators 402a and 402b of the system 400, and hence, will not be discussed in further details herein.

In some embodiments, the section between the translators 502a, 502b and the translators 502c, 502d are based on the PNC protocol, while the section between the translators 502a, 502b and the device 104 is based on the RR protocol. Similarly, in some embodiments, the section between the translators 502c, 502d and the device 108 is also based on the RR protocol. In some embodiments, because each of the NI 530a and 530a is coupled to a corresponding RR device, the NIs 530a and 530b are referred to as RR NIs.

In some embodiments, in a PNC protocol, a set of ordering rules is used to arbitrate and control flow of various types of commands. Table 1 below illustrates various example ordering rules for a PNC protocol (also referred to herein as “PNC ordering rules”), e.g., specifies which flow class can overtake another flow class during arbitration of the commands using a shared connection. In some embodiments, the rules in Table 1 is applicable in the PNC domain (e.g., and not necessarily in the RR domain).

TABLE 1
(PNC ordering rule)

| Rule | |
|---|---|
| No. | Rule description |
| 1 | Within the same flow class, order is preserved |
| 2 | Non-Posted is not allowed to overtake Posted |
| 3 | Completion is not allowed to overtake Posted |
| 4 | Posted is allowed to overtake all other flow classes |
| 5 | Completion is allowed to overtake Non-Posted |
| 6 | Non-Posted may or may not be allowed to overtake Completion |

In some embodiments, rule 1 of Table 1 ensures that for a given flow class, an order in which the commands are received is preserved. For example, referring to FIG. 3, if the P flow 312a1 receives a sequence of P commands from the initiator 204a and the P commands are loaded in the FIFO buffer 338a, an order in which the P commands will be output by the arbiter 334a will be same as the order in which the P commands are in the sequence. Although the arbiter 334a will likely interleave NP commands and/or C commands within the P commands output by the arbiter 334a, no P command in the flow 312a1 can overtake another P command in the arbiter output. For example, if a first P command is ahead of a second P command in the P flow 312a1 (and also in the buffer 338a), the first P command will always be output before the second P command by the arbiter 334a (although, there may be intervening NP and/or C commands between the first and second P commands output by the arbiter 334a). Similarly, a sequence of the NP commands (or the C commands) present in the NP flow 312b1 (or in the C flow 316c2) is maintained in the output of the arbiter 334a. Thus, rule 1 maintains basic consistency of the PNC protocol.

In some embodiments, rule 2 of Table 1 ensures that if a NP command (e.g., from the NP flow 312b1) and a P command (e.g., from the P flow 312a1) are received simultaneously or near simultaneously by an arbiter (e.g., the arbiter 334a), the NP command is not allowed to overtake the P command. For example, the arbiter 334a ensures that the P command precedes the NP command. In some embodiments, the NP command is generally a read command, and the P command is generally a write command without an acknowledgement. Thus, the rule 2 of the Table 2, for example, ensures prevention of a read after write (RAW) hazard (e.g., by ensuring that data to a given memory address is first written to, and then read from the memory address).

In some embodiments, rule 3 of Table 1 ensures that a C command cannot overtake a P command, e.g., if the C command (e.g., from the C flow 316c2) and the P command (e.g., from the P flow 312a1) are received simultaneously or near simultaneously by an arbiter (e.g., the arbiter 334a). In some embodiments, such a rule ensures basic ordering in the PNC protocol, which requires that a posted command is given priority over a completion command.

In some embodiments, rule 4 of Table 1 ensures that a P command can overtake commands from all other classes, e.g., the P command can overtake a NP command and/or a C command that are simultaneously or near simultaneously received by an arbiter. For example, if a P command (e.g., from the P flow class 312a1) is received simultaneously or substantially simultaneously with a C command (e.g., from the C flow 316c2) and/or a NP command (e.g., from the NP flow 312b1) by an arbiter (e.g., the arbiter 334a), then the arbiter allows the P command to overtake the NP command and/or the C command. In some embodiments, such a rule ensures deadlock avoidance in the PNC network.

In some embodiments, rule 5 of Table 1 ensures that a C command can overtake a NP command, e.g., if the C and the NP commands are simultaneously or near simultaneously received by an arbiter. In some embodiments, such a rule also ensures deadlock avoidance in the PNC protocol. For example, such a rule ensures that a C command associated with a previous NP command (e.g., where the C command is in response to a previous NP command) is allowed to pass prior to a most current NP command, e.g., there avoiding a deadlock situation. In some embodiments, the rule 6 of the Table 1 ensures that a NP command may or may not be allowed to overtake a C command.

In some embodiments, in a RR protocol, an ordering rule is used to arbitrate and control flow of various types of commands. Table 2 below illustrates various example ordering rules for a RR protocol, e.g., specifies how flow classes are handled in the RR domain. In some embodiments, these rules prevent deadlock situation in the RR network.

TABLE 2
(RR rule)

| Rule | |
|---|---|
| No. | Rule description |
| 1 | Request and response network are independent. |
| 2 | Targets when having accepted a request are able to produce the |
| | response after a finite amount of time, regardless what is further |
| | coming in on the request network. But targets may stop accepting |
| | further requests, as long as their limit of outstanding responses is |
| | reached. |
| 3 | Initiators who have sent out a request that produces a response will |
| | accept that response after a finite amount of time, regardless of |
| | other requests that they might (want to) produce. |

In some embodiments, rule 1 of Table 2 dictates that requests are dealt independent of responses, and the request network is independent of the response network. This rule, for example, ensures that a stall in a request network does not affect the response network, and vice versa.

In some embodiments, rule 2 of Table 2 ensures that a target (e.g., the target 104b of the device 104 of FIG. 4), when having accepted a request, is able to produce a corresponding response after a finite amount of time, regardless of further requests coming through the request network. This ensures that a response to a request is generated within a finite amount of time, regardless of the number of requests that a target subsequently receives. This rule also, for example, enables a target to stop accepting requests if, for example, the target's limit of outstanding responses is reached (e.g., once the number of outstanding responses reached a threshold value).

In some embodiments, rule 3 of Table 2 ensures that an initiator (e.g., the initiator 104a of the device 104 of FIG. 4), who has sent out a request that generates a response, will accept that response after a finite amount of time, regardless of other requests that the initiator might want to produce. For example, assume that the initiator 104a transmits a first request over the request flow 450a, in response to which the initiator 104a receives a first response after some time. Rule 3 dictates that the initiator 104a will accept the first response within a finite amount of time of receiving the first response, regardless of other requests that the initiator 104a might want to produce.

In some embodiments, some of the rules of Table 1 associated with the PNC network may contradict or violate some of the rules of Table 2 associated with the RR network. For example, the rule 3 of Table 1 (e.g., which states that Completion is not allowed to overtake Posted) may contradict the rule 1 of Table 2 (e.g., which states that Request and response network are independent). For example, since responses from a target are not allowed to overtake posted write requests of the initiator part on the same shared network interface (e.g., as dictated by the PNC rule 3 of Table 1), the responses may not advance independent of the requests any more (e.g., which may violate the RR rule 1 of Table 1). So, if a network interface is built to make a standard bus protocol initiator/target pair to observe the PNC ordering rules (e.g., so that it may communicate with a PNC style component), it has to be ensured that the amount of outstanding non-posted requests to a target can get their responses stored in a separate buffer. Such a separate buffer, for example, can be within a translator of a network interface, where the translator of a network interface is discussed herein later, e.g., as illustrated in the network interfaces of FIGS. 3-5. Such an arrangement, for example, may ensure that a response may linger in the buffer, until, for example, the PNC ordering rules (e.g., from Table 1) allows the response to advance behind the posted requests of the initiator. Such an arrangement, for example, may also ensure that the request network to a target is not stalled because responses cannot advance, thereby repairing the violation of the rule 1 of Table 2, and avoiding a violation of rule 3 of Table 2.

In some embodiments, in a PNC protocol, a set of rules is used to avoid deadlocks in a PNC network. Table 3 below illustrates various example deadlock avoidance rules for a PNC protocol (also referred to herein as “PNC deadlock avoidance rules,” or alternatively as PNC-DL rule).

TABLE 3
(PNC deadlock avoidance rule or PNC-DL Rule)

| Rule | |
|---|---|
| No. | Rule description |
| 1 | Although initiator and target port are bound together, the logic |
| | behind has to be separate. |
| 2 | Posted requests can always be accepted in a target, independent of |
| | any blockage the initiator may have to send out transactions. |
| 3 | Non-Posted requests to the target can be accepted independent of |
| | Non-Posted requests that the initiator might want to send out. |
| 4 | Completions can be accepted independent of any backpressure to |
| | requests. |
| 5 | Completions must be able to overtake blocked read requests. |
| 6 | Posted requests are always allowed to advance after a finite |
| | amount of time. |

In some embodiments, rule 1 of Table 3 dictates that although an initiator port and a target port in a device can be bounded together, a logic behind the initiator port may work independent of a logic behind the target port. Such separation of logic, for example, aids in achieving rule 1 of Table 2 (e.g., which dictates that a request network and a response network are independent).

In some embodiments, rule 2 of Table 3 dictates that posted requests can always be accepted in a target of a device, e.g., independent of any blockage the initiator may have to send out transactions (e.g., to send out requests). This, for example, is another aspect of the initiator and target logic independency discussed with respect to the above discussed rule 1.

In some embodiments, rule 3 of Table 3 dictates that non-posted requests to a target can be accepted independent of non-posted requests that a corresponding initiator might want to send out. This, for example, is another aspect of the initiator and target logic independency discussed with respect to the above discussed rule 1.

In some embodiments, rule 4 of Table 3 dictates that completion commands can be accepted independent of any backpressure to requests in an initiator. In some embodiments, rule 5 of Table 3 dictates that completions commands must be able to overtake blocked read requests, e.g., to ensure that the completion commands arrive eventually to break any potential stall caused by the limit of outstanding responses every logic has. In some embodiments, rule 6 of Table 3 dictates that posted requests are always allowed to advance after a finite amount of time, e.g., so that a completion command behind a posted command may advance as well.

In some embodiments, rules 5 and 6 of Table 3 requires that a read request (which, for example, is a NP command) be selectively overtaken by a write request (which, for example, is a P command) and/or a read response (which, for example, is a C command). In some embodiments, to enable a read request to be overtaken, the read request has to travel on a different flow class buffer than the write requests and the read responses. As seen in FIGS. 3-5, the network interfaces ensure that each flow class has a corresponding buffer, thereby facilitating satisfaction of rules 5 and 6 of Table 3.

In some embodiments, to be able to meet the rule 6 of Table 3, individual components that may store (and thus might hold or delay) a transaction has to get at least separate stores for P commands and NP commands (e.g., so that the P commands at any time can overtake NP command). As seen in FIGS. 3-5, the network interfaces ensure that each flow class has corresponding buffers, thereby facilitating satisfaction of the rule 6 of Table 3.

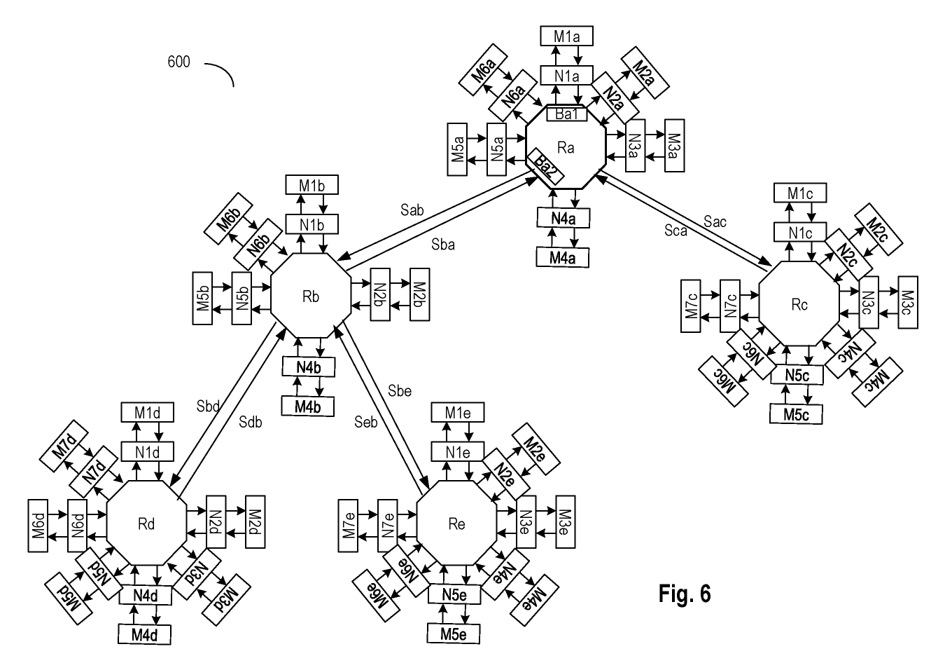

FIG. 6 illustrates an interconnect network 600 (henceforth referred to as a “network 600”) connecting one or more PNC devices with one or more RR devices, according to some embodiments. In some embodiments, the network 600 comprises a plurality of routing devices (henceforth referred to as “routers”) Ra, . . . , Re, generally referred to as a router R in singular, or routers R in plural.

In some embodiments, the routers R are arranged in a tree like topology. For example, the router Ra forms a top node of the tree, and has two branches connecting to two downstream Rb and Rc. Similarly, router Rb has two branches connecting to two downstream routers Rd and Re. Although FIG. 6 illustrates a binary tree with each of the routers Ra and Rb having exactly two children routers, a router can have one, three, or more children routers as well. Although a specific configuration of the tree and a specific number of routers R are illustrated in FIG. 6, such configuration and number are merely examples and do not limit the scope of this disclosure.

In some embodiments, the tree like structure of the network 600 ensures that a router is connected to another router via only a single and unique route. For example, the router Rc is connected to the router Re via, and only via, the routers Ra and Rb. The routers R comprise any appropriate routing devices that can receive data packets and selectively route the received data packets to appropriate destinations. For example, a router R can represent a network comprising multiple routers, switches, buses, multi-layer buses, crossbars, time-multiplexed wires for command and data information (or, for example, separate wires for command and data information), any other appropriate network components, etc.

Each of the routers R is connected to a plurality of components via a corresponding plurality of network interfaces, where the components are generally referred to as a component M in singular or components M in plural, and where the network interfaces are generally referred to as a NI in singular or NIs in plural (and labeled as Nx, where N indicates a network interface, and x identifies the network interface). For example, the router Ra is connected to components M1a, . . . , M6a, e.g., via NIs N1a, . . . , N6a, respectively. Similarly, the router Rb is connected to components M1b, . . . , M6b, e.g., via NIs N1b, . . . , N6b, respectively, and so on. Although FIG. 6 illustrates each router being coupled to a specific number of components, such specific number of components are merely examples and do not limit the scope of this disclosure.

In some embodiments, in the system 600, two neighboring routers are interconnected using corresponding signal lines (e.g., which form the branches of the above discussed router tree). For example, the router Ra is coupled to the Rc via signal lines Sac and Sca, where Sac represents the connection from the router Ra to the router Rc, and where Sca represents the connection from the router Rc to the router Ra. Similarly, for example, the router Rb is coupled to the Re via signal lines Sbe and Seb, where Sbe represents the connection from the router Rb to the router Re, and where Seb represents the connection from the router Re to the router Rb. The signal lines Sab, Sba, Sac, Sca, etc. are in general referred to as signal line S in singular, and signal lines S in plural.

In some embodiments, individual component M can be of any appropriate type, e.g., a processing core (e.g., processor), a memory, a peripheral device, a direct memory access (DMA) device, a PCIe device, a Universal Serial Bus (USB) device, and/or the like. Merely as an example, each router R is coupled to components M comprising at least one processor, at least one memory, and one or more other types of components. A processing core or a processor generally refers to a central processing unit (CPU), an application-specific integrated circuit (ASIC), a network processor, a digital signal processor, a general-purpose processor, and/or the like.

In some embodiments, some of the components M can be RR devices, while some other components can be RR devices. Merely as an example, the component M6a can be a RR devices, while the component M5a can be a PNC device.

In some embodiments, a NI in the network 600 can be one of two types, e.g., based on a type of component to which the NI is connected. For example, if a NI is connected to a RR component, the NI is similar to the NI 430a of FIG. 4 (e.g., the NI is a RR NI). On the other hand, if a NI is connected to a PNC component, the NI is similar to the NI 430b of FIG. 4 (e.g., the NI is a PNC NI). Thus, for the example in which the component M6a is a RR devices and the component M5a is a PNC device, the N6a is a RR NI and the N5a is a PNC NI. For example, the N6a has two translators (e.g., similar to the translators 402a and 402b of FIG. 4) that translates the RR commands from the component M6a to PNC commands. In some embodiments, the routers R and the signal lines S of FIG. 6, for example, correspond to the routers 350, 450 and 550 of FIGS. 3-5, respectively.

In some embodiments, the routers R and the signal lines S operate in accordance with the PNC protocol (e.g., forms a PNC network). Thus, the PNC network comprising the routers R and the signal lines S interconnects one or more PNC components and/or one or more RR components. For individual components M that operate in accordance with the PNC protocol, the corresponding NI need not perform any translation operation; while for the individual components M that operate in accordance with the RR protocol, the corresponding NI performs translation between the RR and PNC protocols, e.g., a discussed with respect to FIG. 4.

In some embodiments, each router has one or more buffers, arbiters, switches, etc., although not all such components are illustrated in FIG. 6. For example, two buffers Bal and Ba2 of the router Ra are illustrated in FIG. 6. In an example, the buffer Bal is configured to buffer data that are transmitted between the router Ra and the network interface N1a. In some embodiments, the buffer Ba1 can be integrated with the network interface N1a. In an example, the buffer Ba2 is configured to buffer data that are transmitted between the router Ra and the signal lines Sab and Sba. Note that as discussed above, the router Ra can have other buffers as well, although not illustrated in FIG. 6.

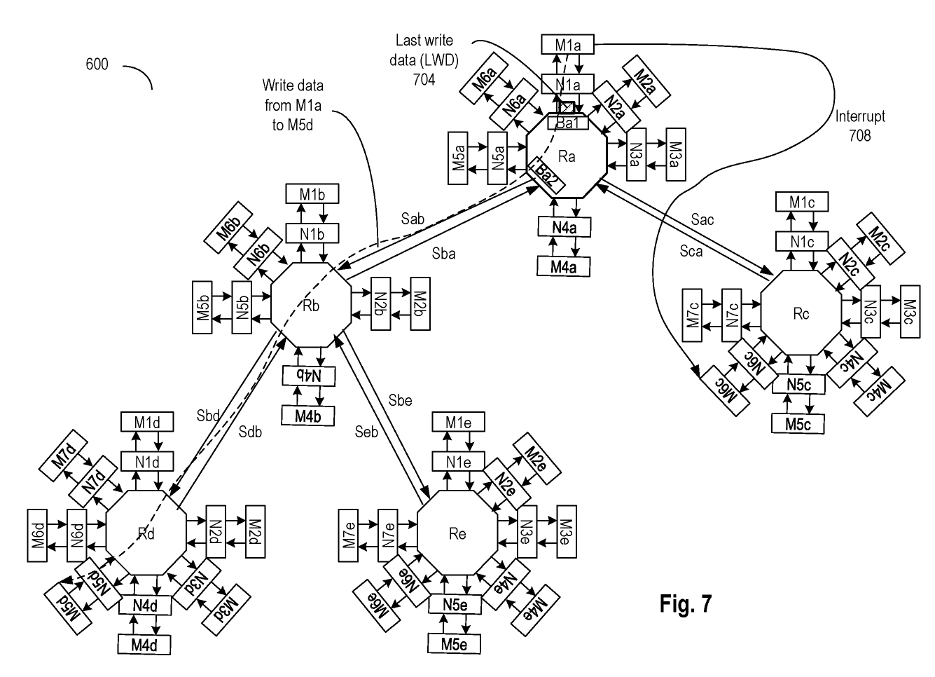

In some examples discussed below (e.g., with respect to FIGS. 7-9), it is assumed that the component M1a is a first processor, the component M5d is a memory, and the component M6c is a second processor. It is also assumed that the first processor M1a is to write data in the memory M5d, which is then to be read by the second processor M6c. Thus, merely as an example, it is assumed that the first processor M1a is a producer of the data, the memory M5d is a target of the data, and the second processor M6c is a consumer of the data.

For the producer M1a to write data to the memory M5d, the producer M1a has to transmit a sequence of write commands to the memory M5d. For the PNC network (e.g., comprising the routers R and the signal lines S), a write command can be, for example, a posted command (e.g., assuming that the write command does not need acknowledgement). The producer M1a can be either a RR device (in which case the RR device issues a write request, which the network interface N1a translates into a posted command), or a PNC device (in which case the PNC device issues a posted command).

FIG. 7 illustrates transmission of write data from the producer M1a to the memory M5d of the network 600 of FIG. 6, according to some embodiments. For example, the write data, in the form of posted commands, are transmitted along the dotted line, e.g., from the producer M1a to the memory component M5d via the network interface N1a, the router Ra (e.g., including the buffer Ba1 and the buffer Ba2), signal line Sab, the router Rb, signal line Sbd, the router Rd, and the network interface N5d.

As discussed, the producer M1a issues a sequence of write commands. Merely as an example, assume that the producer M1a issues four write commands in sequence. In some embodiments, because of rule 1 of Table 1 (e.g., rule 1 of the PNC ordering rules) that states that order is preserved within the same flow class, the first three write commands will be transmitted from the producer M1a to the memory M5d, e.g., before the fourth (e.g., the last) write command is transmitted. The write data in the fourth or last write command is also referred to as last write data (LWD) 704, because the LWD 704 is the last write data in the sequence of write data transmitted from the producer M1a to the memory M5d (the LWD 704 is illustrated using diagonally shaded rectangle in the figures).

In some embodiments, subsequent to the producer M1a issuing the four write commands to write to the memory M5d, the producer M1a issues an interrupt 708 to the consumer M6c. The interrupt 708, for example, is an attempt to make the consumer M6c aware about the writing to the memory M5d, so that the consumer M6c can read the data from the memory M5d. In some embodiments, the interrupt 708 can be transmitted by bypassing the network 600 (e.g., by bypassing the routers R and the signal lines S), as illustrated in FIG. 7.

In some embodiments, the interrupt 708 is generated and transmitted, for example, while the fourth (e.g., the last) write command is still lingering within the router Ra (e.g., because the interrupt 704 is transmitted by the producer M1a, as soon as the producer M1a issues the last write command, without waiting for the LWD 704 to reach the memory M5d). For example, the LWD 704 is still within the router Ra (or can be still within the NI N1a). For example, FIG. 7 illustrates the LWD 704 to be within the buffer Ba1, although the LWD 704 can also be within the network interface N1a.

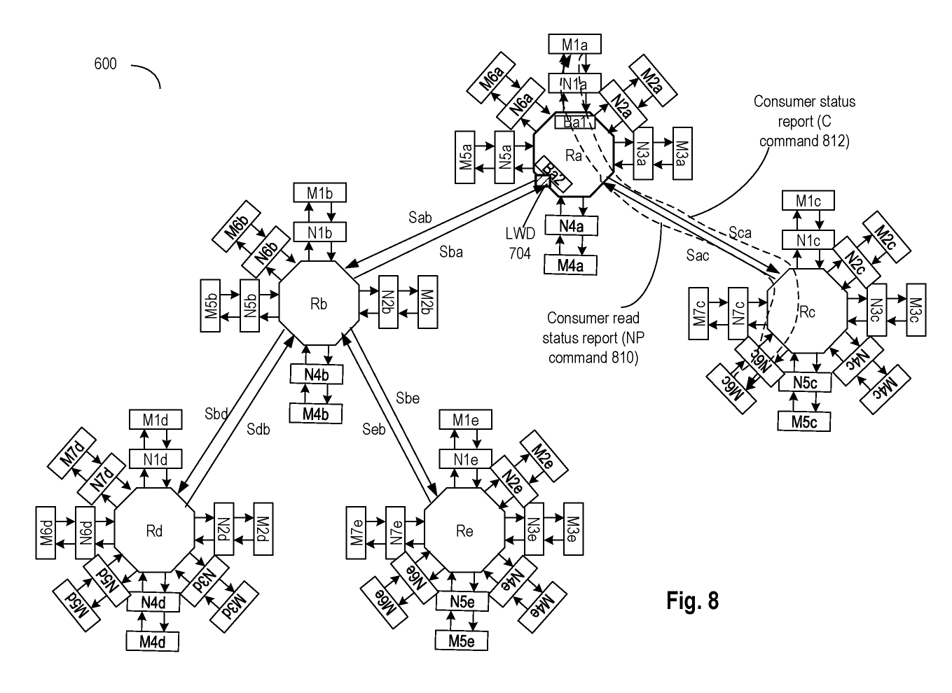

In some embodiments, subsequent to the consumer M6c receiving the interrupt 708, the consumer M6c communicates with the producer M1a, e.g., as illustrated in FIG. 8. For example, as illustrated in FIG. 8, the consumer M6c transmits a consumer read status report, which is a NP command 810, to the producer M1a, in response to receiving the interrupt 708 of FIG. 7. The command 810 is a NP command, because the producer M1a has to respond to the command 810 with a corresponding completion command. In an example, the interrupt 708 merely informs the consumer M6c about relevant information available for the consumer M6c, where the information is stored in the producer M1a. Thus, based on the interrupt 780, the consumer M6c transmits the NP command 810, e.g., to know the details associated with the interrupt 708.

In some embodiments, in response to receiving the NP command 810, the producer M1a transmits a consumer status report, which is a C command 812, to the consumer M6c. The C command 812, for example, specifies that the producer M1a has written data to the memory M5d, and that the consumer M6c can read the data from the memory M5d.

In some embodiments, the NP command 810 and the C command 812 are transmitted via the buffer Ba1 and/or the network interface N1a. Also, in FIG. 7, the LWD 704 was lingering in the buffer Ba1 and/or the network interface N1a. In an example, the C command 812 pushes the LWD 704 out of the buffer Ba1 and/or the network interface N1a, such that the LWD 704 reaches at least the buffer Ba2. The C command 812 can push out the LWD 704 out of the buffer Ba1 and/or the network interface N1a, because the LWD 704 is a part of a P command, and rule 3 of the PNC ordering rules (e.g., Table 1) dictates that completion is not allowed to overtake Posted (e.g., which implies that a C command pushes a P command through an arbiter/buffer). Because of this rule, the LWD 704 is pushed out of the buffer Ba1 and/or the network interface N1a by the C command 812, as illustrated in FIG. 8.

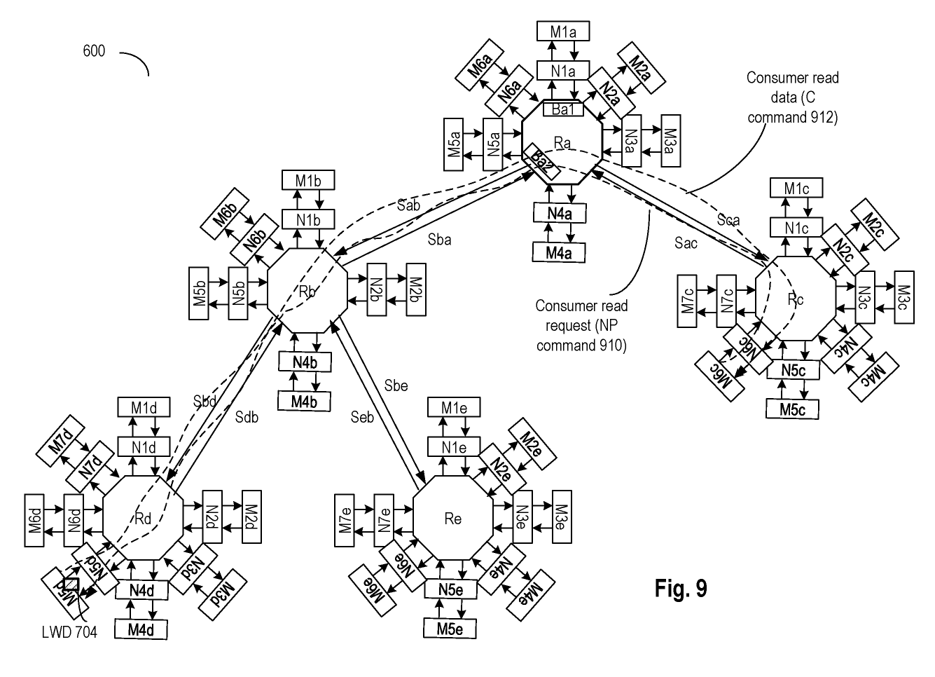

Once the consumer M6c has received the C command 812, the consumer M6c is aware that it has to read data from the memory M5d (e.g., based on analyzing the C command 812). Accordingly, the consumer M6c transmits a consumer read request, which is a NP command 910, to the memory, as illustrated in FIG. 9. The NP command 910 is transmitted via the buffer Ba2 of the router Ra, and the routers Rb and Rd.

Also, note that in FIG. 8, the LWD 704 was still lingering in the buffer Ba2 of the router Ra. Furthermore, rule 2 of the PNC ordering rules (e.g., Table 1) dictates that Non-Posted is not allowed to overtake Posted (e.g., implying that a NP command pushes a P command). Accordingly, the NP command 910 pushes the LWD 704 (e.g., which is a part of a P command) all the way through the memory M5d. For example, because of rule 2 of the PNC ordering rules, it is ensured that the LWD 704 reaches the memory M5d prior to the NP command 910 (e.g., which is a read request to read data from the memory M5d) reaching the memory M5d.

After the read operation is executed in the memory M5d, the read data is transmitted back to the consumer M6c from the memory M5d as a completion command 912.

Thus, the network 600 avoid a read before write (RAW) hazard and maintains data consistency. For example, even though the producer M1a issues the interrupt 708 prior to the LWD 704 reaching the memory M5d, the network 600 ensure that the NP command 910 to read the data is not executed (e.g., the read is not actually performed) until the LWD 704 actually reaches the memory M5d.

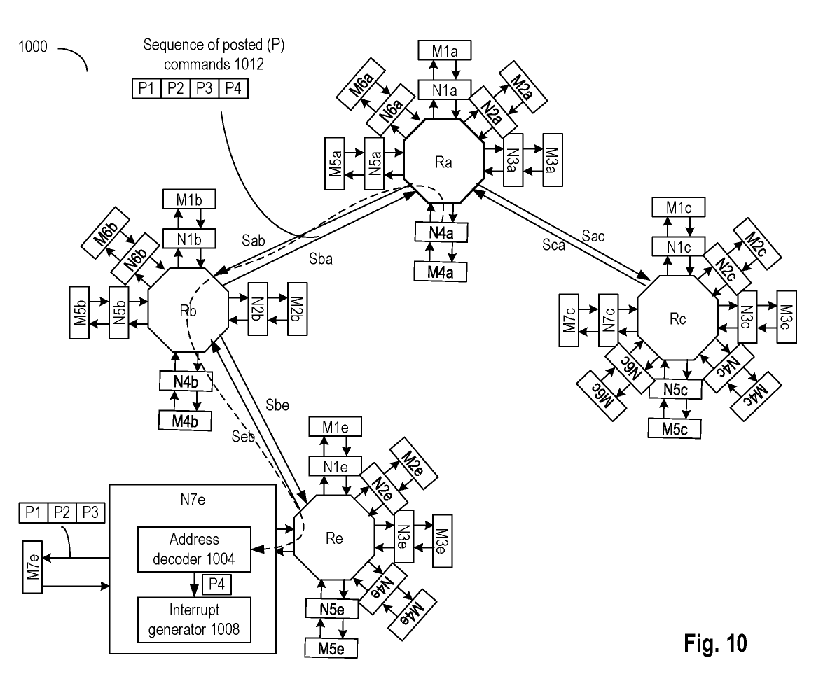

FIG. 10 illustrates an interconnect network 1000 (henceforth referred to as a “network 1000”) connecting one or more PNC devices with one or more RR devices, where an interrupt generator is within a network interface, according to some embodiments. The network 1000 is similar to the network 600 of FIGS. 6-9, and hence, is not discussed in detail. It is to be noted that some of the routers (e.g. router Rd) and/or components are not illustrated in FIG. 10 for purposes of illustrative clarity. In some embodiments, the router Rd may not be present in the network 1000.

Similar to FIGS. 6-9, in some examples discussed below, it is assumed that the component M4a is a first processor, the component M7e is a memory, and the component M7c is a second processor. It is also assumed that the first processor M4a writes data in the memory M7e, which is then to be read by the second processor M7c. Thus, merely as an example, it is assumed that the first processor M4a is a producer of the data, the memory M7e is a target of the data, and the second processor M7c is a consumer of the data.

Merely as an example, is it assumed that the data to be written can be included in three write commands. In some embodiments, the producer M4a issues a sequence of write commands, which, for example comprises a sequence of P commands P1012. For example, the write data is included in three P commands P1, P2, and P3. In some embodiments, the producer M4a also appends with the three write commands an additional P command P4. Thus, the sequence of P commands P1012 comprises P commands P1, . . . , P4, where P1, P, and P3 are write commands, and the command P4 is not a write command. In some examples, the command P4 can be considered as a dummy write command. As illustrated in FIG. 10, the P commands P1012 are transmitted from the producer M4a to the network interface N7e associated with the target memory M7e (e.g., illustrated using dotted lines).

In some embodiments, the network interface N7e comprises, among other components, an address decoder 1004 and an interrupt generator 1008. The address decoder 1004 decodes the addresses of individual commands received by the network interface N7e, and directs the command to an appropriate destination. For example, the P commands P1, P2, and P3, which are included in the sequence of P commands P1012, are write commands destined for the memory M7e. Accordingly, the address decoder 1004 directs the P commands P1, P2, and P3 to the memory M7e. It is to be noted that if, for example, the memory M7e is a RR device, the network interface N7e does a translation of the P commands to appropriate write requests, prior to transmitting to the memory M7e.

In some embodiments, the last P command in the sequence of the P commands P 1012 (e.g., the P4 command) is not a write command. For example, a destination address associated with the command P4 is not for the memory M7e. Merely as an example, the address space assigned to the network interface N7e is partitioned in two sections—a first section having addresses assigned to the memory M7e, and a second section assigned to an interrupt generator 1008. The second section has relatively less addresses than those in the first section. Thus, the command P4, which is the last command in the sequence of P commands 1012, is transmitted to the interrupt generator 1008.

It is to be noted that rule 1 of the PNC ordering (e.g., in Table 1) dictates that within the same flow class, order is preserved. Thus, because all the commands P1, . . . , P4 are P commands, by the time the network interface N7e receives the command P4, the network interface N7e also has received the commands P1, . . . , P3.

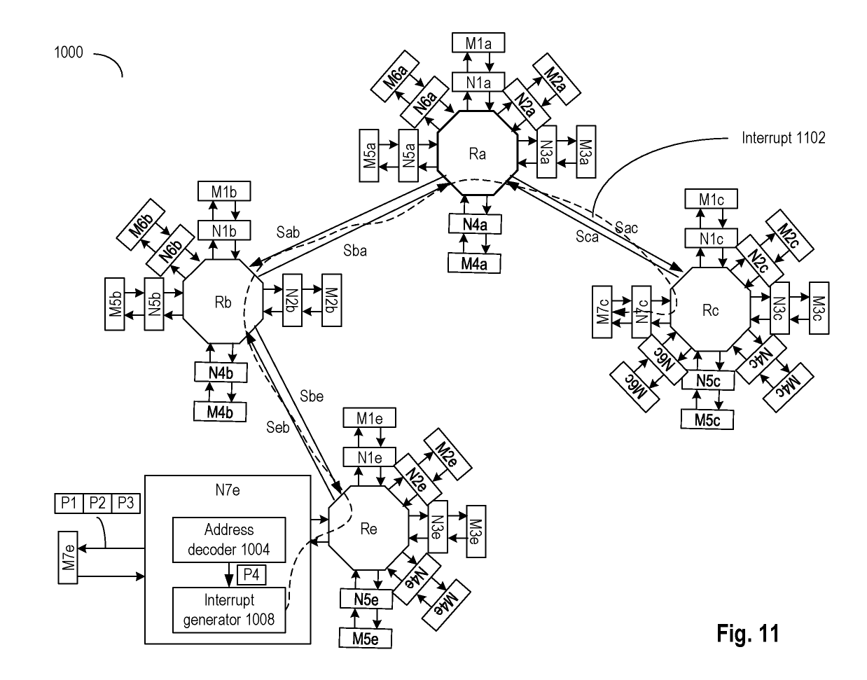

In some embodiments, once the interrupt generator 1008 receives the command P4, the interrupt generator 1008 generates an interrupt 1102 for the consumer M7c, as illustrated in FIG. 11. The interrupt can be, for example, a P command. Although not illustrated in the figures, the consumer M7c, subsequent to receiving the interrupt 1102, performs a read operation to read the data (e.g., which was just written via the commands P1, P2, P3) from the memory M7e. The read process is similar to that discussed with respect to FIG. 9, and hence will not be discussed in further details herein.

Thus, in some embodiments, the last P command in the sequence of P commands 1012 of FIG. 10 being addressed to the interrupt generator 1008 ensures that, for example, the read process initiated by the processor M7c happens only after the data from the P commands P1, P2, and P3 are actually written to the memory M7e. The interrupt 1102 of FIG. 11, for example, is generated only after all the write commands (e.g., the P commands P1, P2, and P3) have actually arrived in the network interface N7e. This prevents accidental reading of data prior to the memory being written to, e.g., prevents the above discussed read after write or RAW hazard, and ensures data consistency in the network 1000.

Although FIG. 11 illustrates transmitting the interrupt 1102 over the network 1000 (e.g., transmitted via the routers Re, Rb, Ra, and Rc), in some other embodiments (and although not illustrated in FIG. 11), the interrupt 1102 can be transmitted instead from the network interface N7e to the consumer M7c by bypassing the routers Re, Rb, Ra, and Rc. For example, the interrupt 1102 can be transmitted from the network interface N7e to the consumer M7c over a direct signal line connecting the network interface N7e and the consumer M7c. Such communication of an interrupt over a direct signal line is discussed with respect to FIG. 7 (e.g., where the interrupt 708 is transmitted over a direct signal line). In some embodiments, in FIG. 11, an address field or a data field of command P4 can encode an identification of the direct signal line that the network interface N7e is to use to transmit the interrupt 1102. In some embodiments, even in the case that the interrupt 1102 is transmitted over a direct signal line connecting the network interface N7e to the consumer M7c, the above discussed RAW hazard would be prevented, e.g., because the interrupt 1102 is generated only after the complete write data has arrived in at least the NI N7e. Thus, any transport mechanism can be chosen for transmission of the interrupt 1102 from the network interface N7e to the consumer M7c (e.g., either (i) via the network 1000 comprising the routers Re, Rb, Ra, Rc, or (ii) via a direct signal line connecting the network interface N7e and the consumer M7c), without losing the proper write and read ordering.

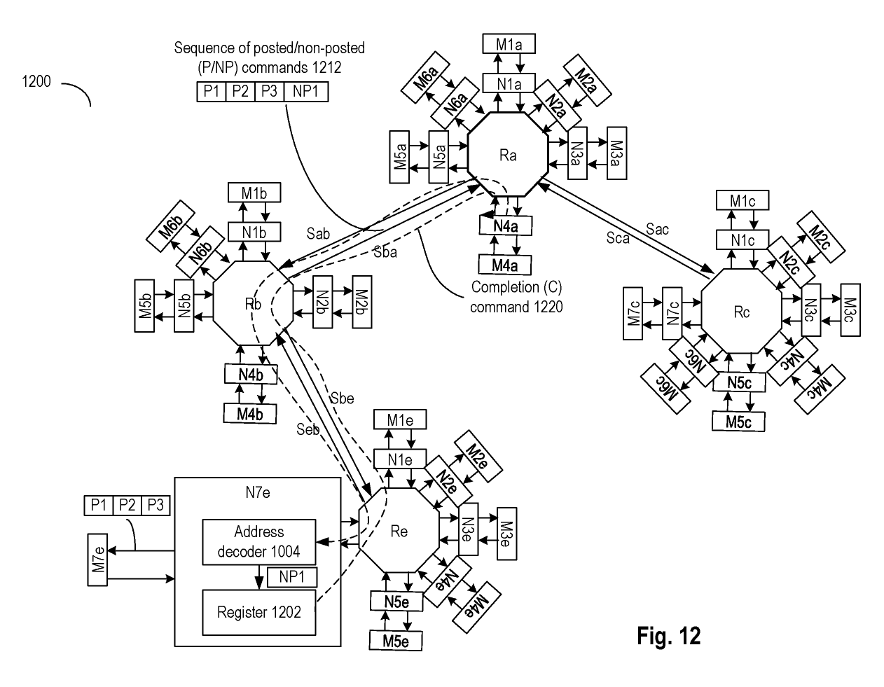

FIG. 12 illustrates an interconnect network 1200 (henceforth referred to as a “network 1200”) connecting one or more PNC devices with one or more RR devices, where a non-posted command is executed after a series of posted write command, according to some embodiments. The network 1200 is similar to the network 1000 of FIGS. 10-11, and hence, is not discussed in detail.

Similar to FIGS. 10-11, in some examples discussed below, it is assumed that the first processor M4a writes data in the memory M7e, which is then to be read by the second processor M7c. Thus, merely as an example, it is assumed that the first processor M4a is a producer of the data, the memory M7e is a target of the data, and the second processor M7c is a consumer of the data.

Similar to FIGS. 10-11 and as an example, is it assumed that the data to be written can be included in three write commands P1, P2, and P3. In the embodiment of FIG. 12, the three write commands P1, P2, and P3 are followed by a non-posted dummy write command NP1. Thus, a sequence of posted/non-posted (P/NP) commands 1212, comprising commands P1, P2, P3, and NP1, is transmitted by the producer N4a.

Also, rule 2 of Table 1 specifies that a non-posted command is not allowed to overtake a posted command. Accordingly, by the time the command NP1 reaches the network interface N7e, the posted commands P1, P2, and P3 must have reached the network interface N7e.

In some embodiments, the command NP1 is transmitted by the address decoder 1004 to a register 1202 in the network interface N7e. Also, the network interface N7e transmits a completion command C1220 to the producer M4a, in response to the NP1 command. The producer M4a generates an interrupt (not illustrated in FIG. 12) to the consumer M7c, for reading the data form the memory M7e, only after receiving the C command 1220. Thus, the interrupt is generated only after the commands P1, P3, and P3 has at least reached the network interface N7e, thereby preventing any possible read after write or RAW hazard in the network 1200.

FIG. 12 illustrates the register 1202 in the network interface N7e handling the non-posted command NP1. However, in some embodiments, the memory target M7e can support non-posted write commands. In such embodiments, the non-posted command NP1 can be transmitted to the memory M7e (e.g., instead of the register 1202). For example, in such an embodiment, the register 122 can even be absent from the network interface N7e.

In some embodiments and although not illustrated in FIG. 12, the last write data P3 (e.g., assuming that posted commands P1, P2, and P3 constitutes write data) can be followed by a non-posted read command (e.g., instead of the non-posted write command NP1). Because the memory M7e is generally equipped to handle non-posted read commands, such an example may not require the register 1202 to handle the last non-posted read command (e.g., the register 1202 may even be absent from the NI N7e). Similar to FIG. 12, based on the non-posted read command (that is received after received the posted write commands P1, P2, P3), the memory M7e can transmit a response (e.g., comprising dummy read data, or even actual read data, or something else) to either the producer M4a or the consumer M7c. Based on such a response (which, for example, can be a completion command, e.g., similar to the command C 1220 of FIG. 12), the consumer M7c can start executing read operation to read data from the memory M7e. Similar to FIG. 12, such an operation would also prevent the above discussed RAW hazard.

Referring to FIGS. 3-5, each of the network interfaces in these figures has six buffers for different types of flows. In some embodiments, it may be possible, in some situations, to reduce the number of buffers in a network interface.

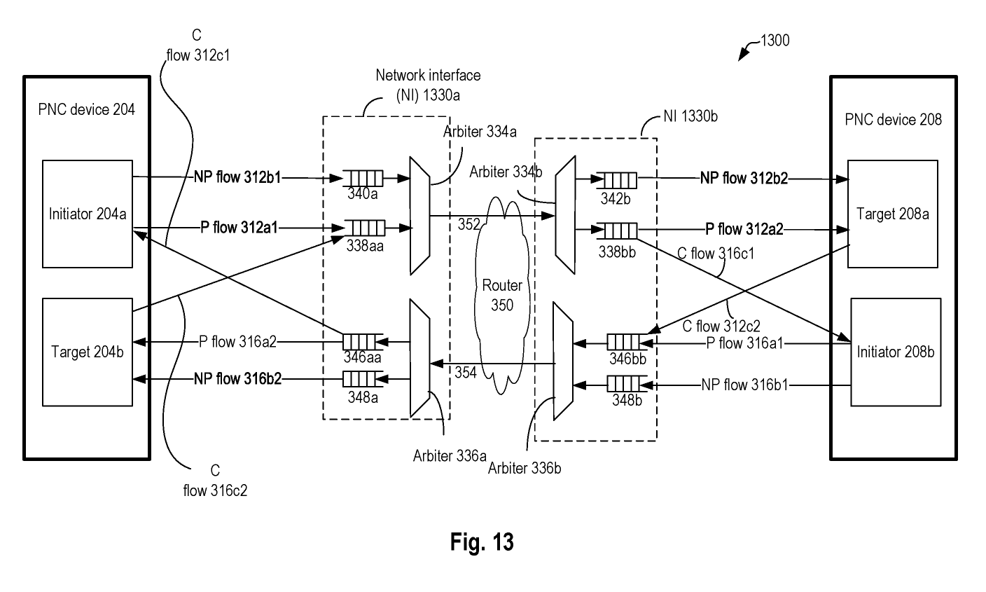

FIG. 13 illustrates a system 1300 comprising the PNC devices 204 and 208 of FIGS. 2-3 communicating via the PNC protocol over a shared connection, where a common buffer stores multiple command flows, according to some embodiment. The system 1300 is substantially similar to the system 300 of FIG. 3. For example, both the systems 300 and 1300 comprises similar components and similar flows, which are labeled using similar labels in FIGS. 3 and 13. For example, similar to FIG. 3, the system 1300 of FIG. 13 comprises various P flows, NP flows, and C flows, various arbiters, and various buffers.

However, unlike FIG. 3, a single common buffer 338aa in FIG. 13 buffers the P flow 312a1 and the C flow 316c2. That is, in FIG. 3, two different buffers 338a and 342a buffered the P flow 312a1 and the C flow 316c2, respectively. However, in FIG. 13, the buffers 338a and 342a are combined in a single buffer 338aa that now handles both the P flow 312a1 and the C flow 316c2. Similarly, a single buffer 346aa in FIG. 13 buffers the P flow 316a2 and the C flow 312c1. Also, a single buffer 338bb in FIG. 13 buffers the P flow 312a2 and the C flow 316c1, and a single buffer 346bb in FIG. 13 buffers the P flow 316a1 and the C flow 312c2.

In some embodiments, the PNC ordering rules of Table 1 are preserved by the system 1300 of FIG. 13. For example, the rule 3 of the PNC ordering rules states that a completion command is not allowed to overtake a posted command. Because in the system 1300 the C commands and the P commands are buffered in FIFO buffers (e.g., in the FIFO buffer 338aa), a C command cannot overtake a P command anyway, as long as these commands are buffered in the same FIFO buffer. Furthermore, because the C commands are buffered separately from the NP commands, a C command can overtake a NP command, thereby satisfying the rule 5 of Table 1 associated with deadlock avoidance. Also, as the C commands progress through the combined buffers and the arbiters, the C commands pushes any potential P commands that are ahead.

In some embodiments, although in the system 1300 the P commands and the C commands progress at the same pace, e.g., thereby slightly potentially impacting the performance of the system 1300 compared to the system 300 of FIG. 3, but a reduction of the buffer sizes significantly reduces the size of the associated network interface.

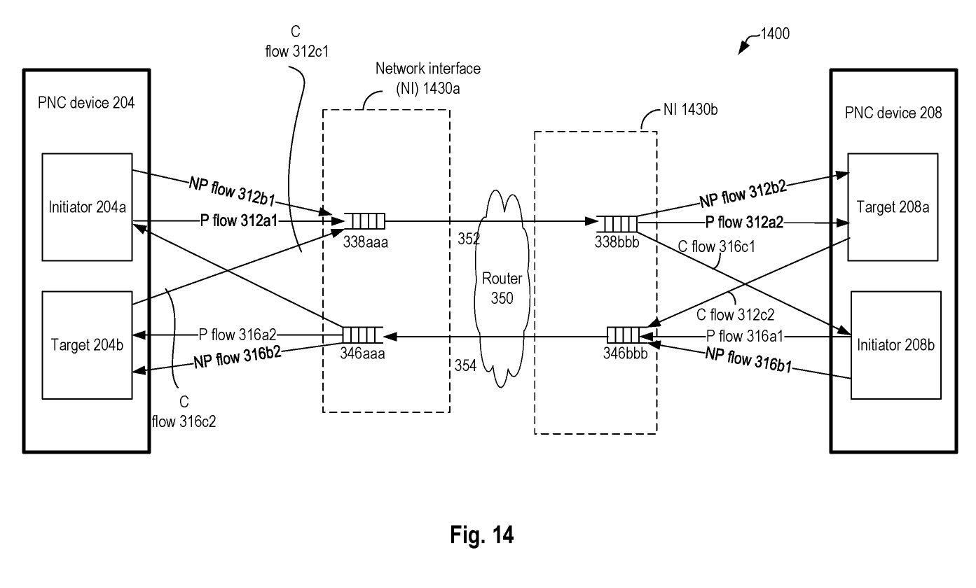

In some embodiments, each of the network interfaces NI 1330a and 1330b has four buffers. The number of buffers can be further reduced, as illustrated in FIG. 14. FIG. 14 illustrates a system 1400 comprising the PNC devices 204 and 208 of FIGS. 2-3 and 13 communicating via the PNC protocol over a shared connection, where a common buffer stores multiple command flows, according to some embodiment. The system 1400 is substantially similar to the systems 300 and 1300 of FIGS. 3 and 13. For example, both the systems 1300 and 1400 comprises similar flows, which are labeled using similar labels in FIGS. 13 and 14. For example, similar to FIG. 13, the system 1400 of FIG. 14 comprises various P flows, NP flows, and C flows, various arbiters, and various buffers.

However, the buffers 340a and 338aa of FIG. 13 are combined in a single buffer 338aaa in the network interface 1430a of FIG. 14. Similarly, the buffers 346aa and 348a of FIG. 13 are combined in a single buffer 346aaa in the network interface 1430a of FIG. 14; the buffers 342b and 338bb of FIG. 13 are combined in a single buffer 338bbb in the network interface 1430b of FIG. 14; and the buffers 348b and 346bb of FIG. 13 are combined in a single buffer 346bbb in the network interface 1430b of FIG. 14. Thus, in FIG. 14, a single buffer in a network interface buffers each of a corresponding P flow, a NP flow, and a C flow. For example, a single flow class FIFO buffer is used for write requests, read requests, and read responses.

In some embodiments, because a single buffer is used for all the three types of flows, no arbitration at the output of the buffer (or at the input of the buffer) may be needed. Accordingly, in some embodiments, the network interfaces NI 1430a and NI 1430b in the system 1400 does not have arbiters, as illustrated in FIG. 14.

In some embodiments, the system 1400 of FIG. 14 violates at least some of the rules of Table 1, and hence, is used for situations where the rule violating situation does not arise. For example, the system 1400 can be applied to situations where there is no possibility to have read requests (e.g., NP commands) and read responses (e.g., C commands) being transmitted in the same direction. Thus, for example, if the buffer 338aaa buffers NP commands, the buffer 338aaa may not buffer any C commands. On the other hand, if the buffer 338aaa buffers C commands, the buffer 338aaa may not buffer any NP commands (e.g., because the NP commands and the C commands may not travel in the same direction).

Not having read requests (e.g., NP commands) and read responses (e.g., C commands) being transmitted in the same direction arises in many practical situations. For example, in an example network (e.g., a trace data network), the initiator 208b can perform write requests, while the initiator 204a can configure the network and can read back configuration registers associated with the network. This, for example, ensures that read requests and read responses are not being transmitted in the same direction.

Each of FIGS. 13 and 14 illustrate network interfaces that interface between two PNC devices. However, the principles of these two figures (e.g., combining buffers of various flows) can be applied, for example, to a network interface that interfaces between a RR device and a PNC device. For example, referring to FIG. 4, the buffers 438a, 440a and 442a of the network interface NI 430a can also be combined (e.g., as a single buffer, or two buffers), e.g., as discussed with respect to FIGS. 13 and 14. Combining various buffers in the network interface 430a of FIG. 4 (or to the network interfaces 530a and 530b of FIG. 5) would be apparent, e.g., based on the discussion with respect to FIGS. 13 and 14, and hence would not be discussed in further details herein.

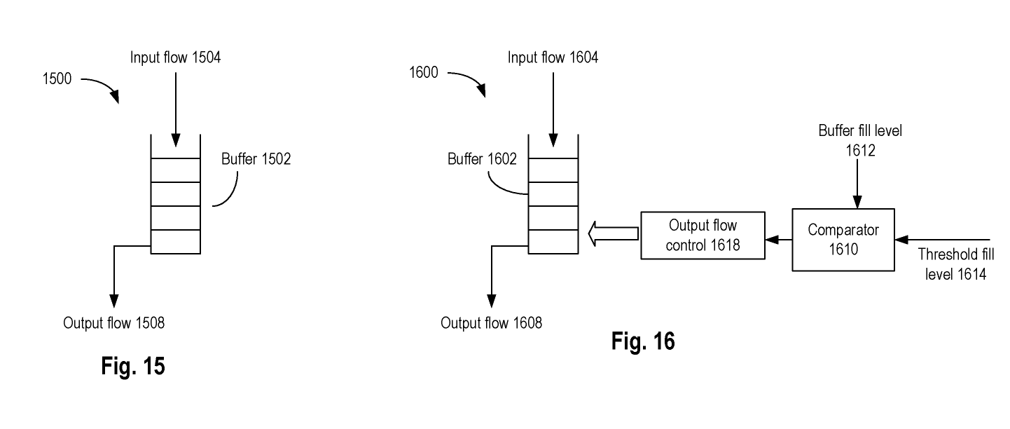

FIG. 15 illustrates a system 1500 for controlling a buffer output of a buffer 1502, according to some embodiments. The buffer 1502, for example, may be included in a network interface or a router (e.g., as discussed with respect to FIGS. 3-14).

The buffer 1502 receives an input flow 1504 comprising data packets. In some embodiments, the data packets are divided in smaller data units called flow control digits (flit). For example, a flit can be a packet, or a section of a packet. For example, the input flow 1504 comprises a stream of flits. In the system 1500, once the buffer 1502 receives a flit from the input flow 1504, the buffer 1502 outputs the flit in the form of an output flow 1508, resulting in a minimal latency in the buffer 1502.

FIG. 16 illustrates a system 1600 for controlling a buffer output of a buffer 1602, according to some embodiments. The buffer 1602, for example, may be included in a network interface or a router (e.g., as discussed with respect to FIGS. 3-14). The buffer 1602 receives an input flow 1604 comprising a stream of flits. The system 1600 further comprises a comparator 1610 configured to receive a signal indicating a buffer fill level 1612 of the buffer 1602. Merely as an example, if about half of the buffer 1602 is full, the buffer fill level 1612 will indicate that information to the comparator 1610. The comparator 1610 also receives a configurable threshold fill level 1614. The comparator 1610 compares the buffer fill level 1612 with the threshold fill level 1614. If the buffer fill level 1612 is higher than the threshold fill level 1614, the comparator 1610 signals an output flow control circuitry 1618 to output the flits from the buffer 1602 in the form of an output flow 1608. Thus, the buffer 1602 is maintained substantially at or about, or below the threshold fill level 1614. In the system 1600, the buffer 1602 stores flits, and then forwards the flits to, for example, an arbiter only when there are sufficient number of flits stored in the buffer 1602.

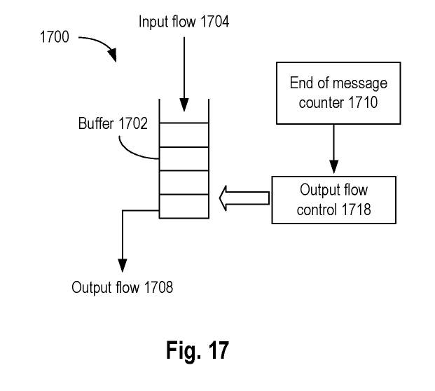

FIG. 17 illustrates a system 1700 for controlling a buffer output of a buffer 1702, according to some embodiments. The buffer 1702, for example, may be included in a network interface or a router (e.g., as discussed with respect to FIGS. 3-14b).

The buffer 1702 receives an input flow 1704 comprising a stream of flits. For example, a message or a command being input in the buffer 1702 (e.g., a P command, a request, a response, a NP command, a C command, or the like) is divided in multiple flits. A flit that is at the end of the message has an indication that it is the last flit of the message. For example, the last flit of the message provides an end of message indication.

In some embodiments, the system 1700 comprises an end of message counter 1710 (henceforth also referred to as a “counter 1710”). The counter 1710 counts the number of end of message flits in the buffer 1702. Thus, if the buffer 1702 currently stores two full messages, then the counter 1710 will have a value of two.

In some embodiments, the system 1700 further comprises an output flow control logic 1718, which receives the end of message count from the counter 1710. If the count value if higher than a threshold value, the messages in the buffer 1702 are output as an output flow 1708. Thus, in the system 1700, the buffer 1702 stores messages, and then forwards the messages to, for example, an arbiter only when there are sufficient number of full messages stored in the buffer 1702.

Comparing the systems 1500-1700, the system 1500 has low latency, whereas the systems 1600 and 1700 have relatively high latency. Furthermore, the system outputs flits at a higher frequency, whereas the systems 1600 and 1700 outputs whole messages. In some embodiments, a buffer can be configured to be operated in one of the three ways discussed with respect to FIGS. 15-17, respectively. For example, a combined system can have the components of the systems 1500-1700. The combined system can be configured to operate as any one of the three systems discussed above.

For example, if a mode of operation of the system 1500 is assumed to be a first mode, a mode of operation of the system 1600 is assumed to be a second mode, and a mode of operation of the system 1700 is assumed to be a third mode, a buffer in the combined system can operate in any of the first, second or third modes. In some embodiments, the combined system can also dynamically or adaptively change a mode of operation. For example, when a low latency is desired, the combined system can operate in the first mode.

In some examples, the buffer in the combined system can be included within a network interface that interfaces between a RR device and a PNC network. In some embodiments, the RR device and the PNC network can have different clock frequency and/or different width of signal lines. In some embodiments, a selection of an operating mode of the combined system, for example, can be based on a difference in the clock frequency in the two domains, difference in the width of the signal lines, etc. For example, a slow domain can include a relatively slow clock signal and/or a relatively narrow width of signal lines, e.g., compared to a fast domain.

In some embodiments, when the buffer in the combined system routes flits from a slow domain to a fast domain, the flits are accumulated in the buffer relatively slowly (e.g., because the slow domain transmits the flits at a slower rate). Hence, in such a system and merely as an example, if sufficient bandwidth is available to process the flits, the first mode (e.g., the system 1500) can be employed at the combined system. On the other hand, for example, when the buffer in the combined system routes flits from a fast domain to a slow domain, the flits are accumulated in the buffer relatively quickly (e.g., because the fast domain transmits the flits at a faster rate). In such a situation and merely as an example, the second or the third mode associated with the system 1600 or 1700 may be utilized.

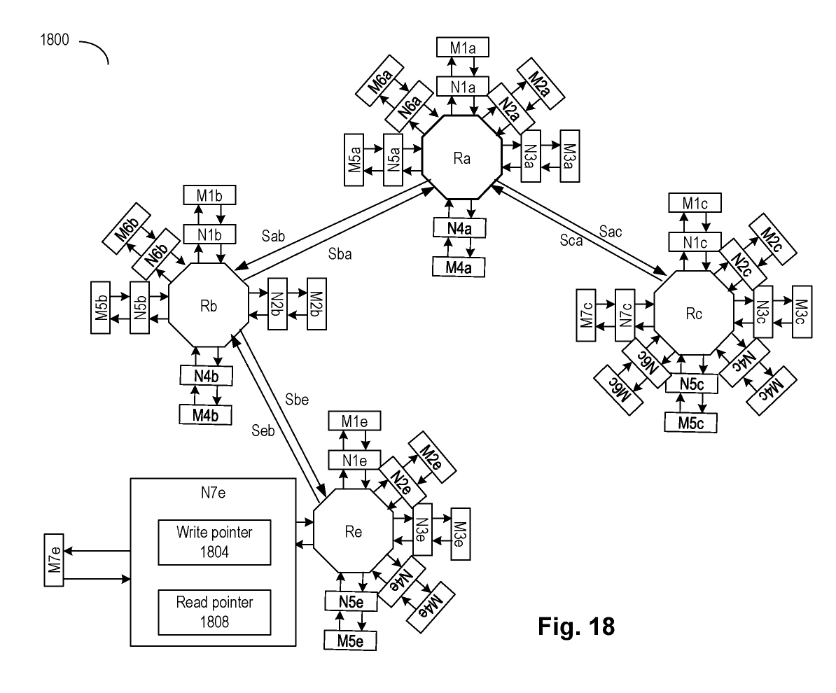

FIG. 18 illustrates an interconnect network 1800 (henceforth referred to as a “network 1800”) connecting one or more PNC devices with one or more RR devices, according to some embodiments. The network 1800 is similar to the network 1000 of FIGS. 10-11, and hence, is not discussed in detail.

Similar to FIGS. 10-11, in some examples discussed below, it is assumed that the first processor M4a writes data in the memory M7e, which is then to be read by the second processor M7c. Thus, merely as an example, it is assumed that the first processor M4a is a producer of the data, the memory M7e is a target of the data, and the second processor M7c is a consumer of the data.

In some embodiments, the NI N1e (e.g., which is coupled to the memory M7e) comprises a read pointer 1808 and a write pointer 1804. The read pointer 1808 and the write pointer 1804, for example, are appropriately controlled by a pointer mechanism and are, for example, stored in respective registers. In some embodiments, the read pointer 1808 and the write pointer 1804 respectively points to a memory address in the memory M7e where data is currently being read from, or written to. In some embodiments, the consumer of the data, e.g., the consumer M7c, can read the values stored in the read pointer 1808 and the write pointer 1804, e.g., to determine if the write operation is completed and/or if new data is available for reading, based on which the consumer M7c can read data form the memory M7e. In some embodiments, the producer of the data, e.g., producer M4a can also read the read pointer 1808 and/or the write pointer 1804 to determine if the data is written to the memory M7e, e.g., based on which the producer M4a can send further data to the memory M7e for writing. In some embodiments, the read pointer 1808 and the write pointer 1804 prevents read after write (RAW) hazard, and helps ensure consistency in the network 1800.

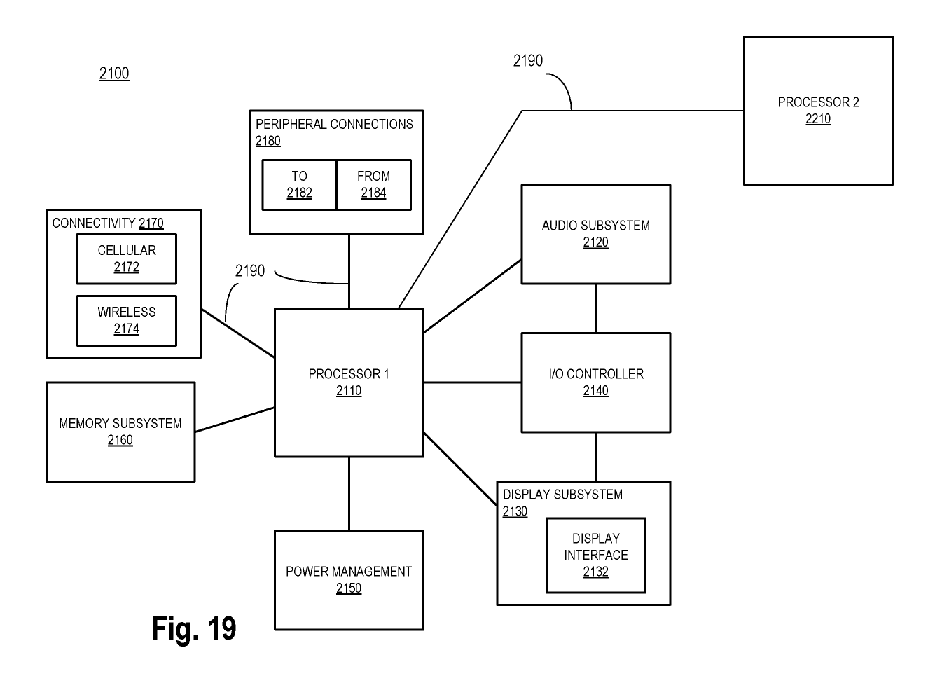

FIG. 19 illustrates a computing device 2100 (e.g., a smart device, a computing device or a computer system or a SoC (System-on-Chip)), where various components of the computing device 2100 are interconnect over a network 2190, according to some embodiments. It is pointed out that those elements of FIG. 19 having the same reference numbers (or names) as the elements of any other figure can operate or function in any manner similar to that described, but are not limited to such.

In some embodiments, the computing device 2100 represents an appropriate computing device, such as a computing tablet, a mobile phone or smart-phone, a laptop, a desktop, an IOT (internet-of-things) device, a server, a set-top box, a wireless-enabled e-reader, or the like. It will be understood that certain components are shown generally, and not all components of such a device are shown in computing device 2100.

In some embodiments, computing device 2100 includes a first processor 2110 and a second processor 2210. The various embodiments of the present disclosure may also comprise a network interface within 2170 such as a wireless interface so that a system embodiment may be incorporated into a wireless device, for example, cell phone or personal digital assistant.

In one embodiment, processors 2110 and/or 2210 can include one or more physical devices, such as microprocessors, application processors, microcontrollers, programmable logic devices, or other processing means. The processing operations performed by processor 2110 include the execution of an operating platform or operating system on which applications and/or device functions are executed. The processing operations include operations related to I/O (input/output) with a human user or with other devices, operations related to power management, and/or operations related to connecting the computing device 2100 to another device. The processing operations may also include operations related to audio I/O and/or display I/O.

In one embodiment, computing device 2100 includes audio subsystem 2120, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into computing device 2100, or connected to the computing device 2100. In one embodiment, a user interacts with the computing device 2100 by providing audio commands that are received and processed by processor 2110.

Display subsystem 2130 represents hardware (e.g., display devices) and software (e.g., drivers) components that provide a visual and/or tactile display for a user to interact with the computing device 2100. Display subsystem 2130 includes display interface 2132, which includes the particular screen or hardware device used to provide a display to a user. In one embodiment, display interface 2132 includes logic separate from processor 2110 to perform at least some processing related to the display. In one embodiment, display subsystem 2130 includes a touch screen (or touch pad) device that provides both output and input to a user.

I/O controller 2140 represents hardware devices and software components related to interaction with a user. I/O controller 2140 is operable to manage hardware that is part of audio subsystem 2120 and/or display subsystem 2130. Additionally, I/O controller 2140 illustrates a connection point for additional devices that connect to computing device 2100 through which a user might interact with the system. For example, devices that can be attached to the computing device 2100 might include microphone devices, speaker or stereo systems, video systems or other display devices, keyboard or keypad devices, or other I/O devices for use with specific applications such as card readers or other devices.

As mentioned above, I/O controller 2140 can interact with audio subsystem 2120 and/or display subsystem 2130. For example, input through a microphone or other audio device can provide input or commands for one or more applications or functions of the computing device 2100. Additionally, audio output can be provided instead of, or in addition to display output. In another example, if display subsystem 2130 includes a touch screen, the display device also acts as an input device, which can be at least partially managed by I/O controller 2140. There can also be additional buttons or switches on the computing device 2100 to provide I/O functions managed by I/O controller 2140.

In one embodiment, I/O controller 2140 manages devices such as accelerometers, cameras, light sensors or other environmental sensors, or other hardware that can be included in the computing device 2100. The input can be part of direct user interaction, as well as providing environmental input to the system to influence its operations (such as filtering for noise, adjusting displays for brightness detection, applying a flash for a camera, or other features).

In one embodiment, computing device 2100 includes power management 2150 that manages battery power usage, charging of the battery, and features related to power saving operation. Memory subsystem 2160 includes memory devices for storing information in computing device 2100. Memory can include nonvolatile (state does not change if power to the memory device is interrupted) and/or volatile (state is indeterminate if power to the memory device is interrupted) memory devices. Memory subsystem 2160 can store application data, user data, music, photos, documents, or other data, as well as system data (whether long-term or temporary) related to the execution of the applications and functions of the computing device 2100.

Elements of embodiments are also provided as a machine-readable medium (e.g., memory 2160) for storing the computer-executable instructions (e.g., instructions to implement any other processes discussed herein). The machine-readable medium (e.g., memory 2160) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

Connectivity 2170 includes hardware devices (e.g., wireless and/or wired connectors and communication hardware) and software components (e.g., drivers, protocol stacks) to enable the computing device 2100 to communicate with external devices. The computing device 2100 could be separate devices, such as other computing devices, wireless access points or base stations, as well as peripherals such as headsets, printers, or other devices.

Connectivity 2170 can include multiple different types of connectivity. To generalize, the computing device 2100 is illustrated with cellular connectivity 2172 and wireless connectivity 2174. Cellular connectivity 2172 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, or other cellular service standards. Wireless connectivity (or wireless interface) 2174 refers to wireless connectivity that is not cellular, and can include personal area networks (such as Bluetooth, Near Field, etc.), local area networks (such as Wi-Fi), and/or wide area networks (such as WiMax), or other wireless communication.

Peripheral connections 2180 include hardware interfaces and connectors, as well as software components (e.g., drivers, protocol stacks) to make peripheral connections. It will be understood that the computing device 2100 could both be a peripheral device (“to” 2182) to other computing devices, as well as have peripheral devices (“from” 2184) connected to it. The computing device 2100 commonly has a “docking” connector to connect to other computing devices for purposes such as managing (e.g., downloading and/or uploading, changing, synchronizing) content on computing device 2100. Additionally, a docking connector can allow computing device 2100 to connect to certain peripherals that allow the computing device 2100 to control content output, for example, to audiovisual or other systems.

In addition to a proprietary docking connector or other proprietary connection hardware, the computing device 2100 can make peripheral connections 2180 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

In some embodiments, some of the components of the computing device 2100 comprises RR devices, while some other components of the computing device 2100 comprises PNC devices. In some embodiments, various components of the computing device 2100 are interconnected using an interconnect network 2190. Although not illustrated in FIG. 19, in some embodiments, the network 2190 comprises one or more routers, network interfaces, etc., e.g., as discussed with respect to FIGS. 3-17.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

The following example clauses pertain to further embodiments. Specifics in the examples clauses may be used anywhere in one or more embodiments. All optional features of the apparatus described herein may also be implemented with respect to a method or process.

Clause 1: A network interface comprising: a first buffer configured to buffer a first flow of a first type of commands from a first device to a second device, wherein the first device is configured in accordance with a first bus interconnect protocol and the second device is configured in accordance with a second bus interconnect protocol; a second buffer configured to buffer a second flow of a second type of commands from the first device to the second device; and an arbiter configured to arbitrate between the first flow and the second flow, and selectively output one or more commands of the first type and one or more commands of the second type.

Clause 2: The network interface of clause 1, further comprising: a translator configured to translate a first command that is in accordance with the first bus interconnect protocol to a second command that is in accordance with the second bus interconnect protocol.

Clause 3: The network interface of clause 2, wherein: the first command is a request for reading data that is in accordance with the first bus interconnect protocol; and the second command is a non-posted command that is in accordance with the second bus interconnect protocol.

Clause 4: The network interface of clause 2, wherein: the first command is a request for writing data without acknowledgement that is in accordance with the first bus interconnect protocol; and the second command is a posted command that is in accordance with the second bus interconnect protocol.

Clause 5: The network interface of clause 2, wherein: the first command is a response including read data that is in accordance with the first bus interconnect protocol; and the second command is a completion command that is in accordance with the second bus interconnect protocol.

Clause 6: The network interface of any of clauses 1-5, wherein the first buffer is further configured to: buffer a third flow of a third type of commands from the first device to the second device, wherein the first type of commands comprises posted commands and the third type of commands comprises completion commands.

Clause 7: The network interface of any of clauses 1-6, wherein the second bus interconnect protocol comprises a bus interconnect protocol that uses one or more of posted commands, non-posted commands, and completion commands to communicate.

Clause 8: The network interface of any of clauses 1-7, wherein the second bus interconnect protocol comprises one of the Peripheral Component Interconnect (PCI) protocol, the Peripheral Component Interconnect Express (PCIe) protocol, or a bus interconnect protocol derived thereof.

Clause 9: The network interface of any of clauses 1-8, wherein the arbiter is configured to selectively output the one or more commands to a network comprising one or more routers and one or more other network interfaces, and wherein the network operates in accordance with the second bus interconnect protocol.

Clause 10: An interconnect network comprising: a plurality of routing devices, the plurality of routing devices comprising a first routing device and a second routing device, wherein the plurality of routing devices is arranged in a tree-like structure; a first network interface configured to interface between a first component and the first routing device; and a second network interface configured to interface between a second component and the second routing device, wherein the first component is configured in accordance with a first bus interconnect protocol, wherein the second component is configured in accordance with a second bus interconnect protocol such that the second component uses one or more of posted commands, non-posted commands, or completion commands to communicate with the second network interface.

Clause 11: The interconnect network of clause 10, wherein: at least one of the plurality of routing devices is configured to communicate with a corresponding plurality of network interfaces in accordance with the second bus interconnect protocol.

Clause 12: The interconnect network of any of clauses 10-11, wherein the second network interface comprises: a translator configured to translate one or more commands between the first bus interconnect protocol and the second bus interconnect protocol.

Clause 13: The interconnect network of any of clauses 10-12, wherein: the first component is configured in accordance with the first bus interconnect protocol such that the first component uses requests and responses to communicate with the first network interface.

Clause 14: The interconnect network of any of clauses 10-13, wherein the second network interface comprises: a buffer configured to buffer a first flow of posted commands, a second flow of non-posted commands, and a third flow of completion commands.

Clause 15: The interconnect network of clause 10, wherein the second network interface comprises: a first buffer configured to buffer a first flow of posted commands; a second buffer configured to buffer a second flow of non-posted commands; and a third buffer configured to buffer a third flow of completion commands.

Clause 16: A system comprising: a processing core; a memory, wherein the processing core is configured in accordance with a first bus interconnect protocol and the memory is configured in accordance with a second bus interconnect protocol; a first router and a second router coupled via signal lines, wherein the first router and the second router are configured in accordance with the first bus interconnect protocol; a first network interface configured to interface between the processing core and the first router; and a second network interface configured to interface between the memory and the second router, wherein the second network interface comprises a translator configured to translate a first command that is in accordance with the first bus interconnect protocol to a second command that is in accordance with the second bus interconnect protocol.

Clause 17: The system of clause 16, wherein the second network interface comprises: a first buffer configured to buffer a first flow of a first type of commands from the memory to the processing core; a second buffer configured to buffer a second flow of a second type of commands from the from the memory to the processing core; and an arbiter configured to arbitrate between the first flow and the second flow, and selectively output one or more commands of the first type and one or more commands of the second type to the second router.

Clause 18: The system of clause 17, wherein the first buffer is further configured to: buffer a third flow of a third type of commands from the memory to the processing core, wherein the first type of commands comprises posted commands and the third type of commands comprises completion commands.

Clause 19: The system of any of clauses 16-18, wherein the second bus interconnect protocol comprises a bus interconnect protocol that uses one or more of posted commands, non-posted commands, and completion commands to communicate.

Clause 20: The system of any of clauses 16-19, wherein the second bus interconnect protocol comprises one of the Peripheral Component Interconnect (PCI) protocol, the Peripheral Component Interconnect Express (PCIe) protocol, or a bus interconnect protocol derived thereof.

Clause 21: A method comprising: buffering, using a first buffer, a first flow of a first type of commands from a first device to a second device, wherein the first device is configured in accordance with a first bus interconnect protocol and the second device is configured in accordance with a second bus interconnect protocol; buffering, by a second buffer, a second flow of a second type of commands from the first device to the second device; arbitrating, by an arbiter, between the first flow and the second flow; and selectively outputting, by the arbiter, one or more commands of the first type and one or more commands of the second type.

Clause 22: The method of clause 21, further comprising: translating, by a translator, a first command that is in accordance with the first bus interconnect protocol to a second command that is in accordance with the second bus interconnect protocol.

Clause 23: The method of clause 22, wherein: the first command is a request for reading data that is in accordance with the first bus interconnect protocol; and the second command is a non-posted command that is in accordance with the second bus interconnect protocol.

Clause 24: The method of clause 22, wherein: the first command is a request for writing data without acknowledgement that is in accordance with the first bus interconnect protocol; and the second command is a posted command that is in accordance with the second bus interconnect protocol.

Clause 25: An apparatus comprising means to perform a method in any of the clauses 21-24.

Clause 26: A system comprising: memory; a processor coupled to the memory; the network interface of clauses 1-9; and an interconnect network, wherein the network interface is coupled to, or included in the interconnect network.

Clause 27: Machine-readable storage including machine-readable instructions, when executed, to implement a method or realize an apparatus as in any preceding clause.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

We claim:

1. A network interface comprising:
a first buffer configured to buffer a first flow of a first type of commands from a first device to a second device, wherein the first device is configured in accordance with a first bus interconnect protocol and the second device is configured in accordance with a second bus interconnect protocol;
a second buffer configured to buffer a second flow of a second type of commands from the first device to the second device; and
an arbiter configured to arbitrate between the first flow and the second flow, and selectively output one or more commands of the first type and one or more commands of the second type.

2. The network interface of claim 1, further comprising:
a translator configured to translate a first command that is in accordance with the first bus interconnect protocol to a second command that is in accordance with the second bus interconnect protocol.

3. The network interface of claim 2, wherein:
the first command is a request for reading data that is in accordance with the first bus interconnect protocol; and
the second command is a non-posted command that is in accordance with the second bus interconnect protocol.

4. The network interface of claim 2, wherein:
the first command is a request for writing data without acknowledgement that is in accordance with the first bus interconnect protocol; and
the second command is a posted command that is in accordance with the second bus interconnect protocol.

5. The network interface of claim 2, wherein:
the first command is a response including read data that is in accordance with the first bus interconnect protocol; and
the second command is a completion command that is in accordance with the second bus interconnect protocol.

6. The network interface of claim 1, wherein the first buffer is further configured to:
buffer a third flow of a third type of commands from the first device to the second device, wherein the first type of commands comprises posted commands and the third type of commands comprises completion commands.

7. The network interface of claim 1, wherein the second bus interconnect protocol comprises a bus interconnect protocol that uses one or more of posted commands, non-posted commands, and completion commands to communicate.

8. The network interface of claim 1, wherein the second bus interconnect protocol comprises one of the Peripheral Component Interconnect (PCI) protocol, the Peripheral Component Interconnect Express (PCIe) protocol, or a bus interconnect protocol derived thereof.

9. The network interface of claim 1, wherein the arbiter is configured to selectively output the one or more commands to a network comprising one or more routers and one or more other network interfaces, and wherein the network operates in accordance with the second bus interconnect protocol.

10. An interconnect network comprising:
a plurality of routing devices, the plurality of routing devices comprising a first routing device and a second routing device, wherein the plurality of routing devices is arranged in a tree-like structure;
a first network interface configured to interface between a first component and the first routing device; and
a second network interface configured to interface between a second component and the second routing device, wherein the first component is configured in accordance with a first bus interconnect protocol, wherein the second component is configured in accordance with a second bus interconnect protocol such that the second component uses one or more of posted commands, non-posted commands, or completion commands to communicate with the second network interface.

11. The interconnect network of claim 10, wherein:
at least one of the plurality of routing devices is configured to communicate with a corresponding plurality of network interfaces in accordance with the second bus interconnect protocol.

12. The interconnect network of claim 10, wherein the second network interface comprises:
a translator configured to translate one or more commands between the first bus interconnect protocol and the second bus interconnect protocol.

13. The interconnect network of claim 10, wherein:
the first component is configured in accordance with the first bus interconnect protocol such that the first component uses requests and responses to communicate with the first network interface.

14. The interconnect network of claim 10, wherein the second network interface comprises:
a buffer configured to buffer a first flow of posted commands, a second flow of non-posted commands, and a third flow of completion commands.

15. The interconnect network of claim 10, wherein the second network interface comprises:
a first buffer configured to buffer a first flow of posted commands;
a second buffer configured to buffer a second flow of non-posted commands; and
a third buffer configured to buffer a third flow of completion commands.

16. A system comprising:
a processing core;
a memory, wherein the processing core is configured in accordance with a first bus interconnect protocol and the memory is configured in accordance with a second bus interconnect protocol;
a first router and a second router coupled via signal lines, wherein the first router and the second router are configured in accordance with the first bus interconnect protocol;
a first network interface configured to interface between the processing core and the first router; and
a second network interface configured to interface between the memory and the second router,
wherein the second network interface comprises a translator configured to translate a first command that is in accordance with the first bus interconnect protocol to a second command that is in accordance with the second bus interconnect protocol.

17. The system of claim 16, wherein the second network interface comprises:
a first buffer configured to buffer a first flow of a first type of commands from the memory to the processing core;
a second buffer configured to buffer a second flow of a second type of commands from the from the memory to the processing core; and
an arbiter configured to arbitrate between the first flow and the second flow, and selectively output one or more commands of the first type and one or more commands of the second type to the second router.

18. The system of claim 17, wherein the first buffer is further configured to:
buffer a third flow of a third type of commands from the memory to the processing core, wherein the first type of commands comprises posted commands and the third type of commands comprises completion commands.

19. The system of claim 16, wherein the second bus interconnect protocol comprises a bus interconnect protocol that uses one or more of posted commands, non-posted commands, and completion commands to communicate.

20. The system of claim 16, wherein the second bus interconnect protocol comprises one of the Peripheral Component Interconnect (PCI) protocol, the Peripheral Component Interconnect Express (PCIe) protocol, or a bus interconnect protocol derived thereof.
